(19) United States
(12) Patent Application Publication
(10) Pub. No.: US 2009/0264587 A1
(43) Pub. Date: Oct. 22, 2009

(54) AQUEOUS POLYURETHANE SOLUTIONS FOR POLYURETHANE SYSTEMS

(75) Inventors: Harald Blum, Hafenlohr (DE); Martin Melchiors, Leichlingen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/425,573

(22) Filed: Apr. 17, 2009

(30) Foreign Application Priority Data
Apr. 18, 2008 (EP) 08007568.2

(51) Int. Cl. C08L 75/04

(52) U.S. Cl. 524/591

(57) ABSTRACT

The present invention relates to innovative aqueous polyurethane solutions, to the soluble polyurethanes present therein, to a process for preparing them, and to the use in polyurethane systems.

### RELATED APPLICATIONS

This application claims benefit to European Patent Application No. 08007568.2, filed Apr. 18, 2008, which is incorporated herein by reference in its entirety for all useful purposes.

### BACKGROUND OF THE INVENTION

The present invention relates to innovative aqueous polyurethane solutions, to the soluble polyurethanes present therein, to a process for preparing them, and to the use in polyurethane systems.

Aqueous binders based on polyurethane dispersions are well-established prior art and are described for example in Houben-Weyl, Methoden der organischen Chemie, 4. ed. volume E 20, p. 1659 (1987), J. W. Rosthauser, K. Nachtkamp in “Advances in Urethane Science and Technology”, K. C. Frisch and D. Klempner, Editors, Vol. 10, pp. 121-162 (1987) or D. Dietrich, K. Uhlig in Ullmann's Encyclopedia of Industrial Chemistry, Vol. A 21, p. 677 (1992).

In this context, amino alcohols are synthesis components often described. Thus DE-A 4237965 describes aqueous polyurethane dispersions which are obtained by reaction of di- or polyisocyanates, hydrophobic polyols containing dimer diol and hydrophilicizing compounds. The examples describe dispersion with fairly low solids contents of 25% to 40% by weight, but the use of hydrophobic diols containing dimer diols, which is essential to the invention, severely limits the variability of such products. Any possible and described reaction of the isocyanate-functional intermediate with amino alcohols prior to dispersing is not an essential part of the invention, since trials can be used as well and also since direct dispersing and reaction with water is possible.

DE-A 4337961 describes aqueous coating materials comprising water-dilutable polyurethane resin, preparable by reaction of polyisocyanate, hydrophilicizing components, polyester polyols and/or polyether polyols if desired, and low molecular weight polyols if desired, to give an isocyanate-functional prepolymer having an acid number of 18 to 70 mg KOH/g, some of the isocyanate groups being reacted in a further step with blocking agent, with addition, if desired, of further polyisocyanate and subsequent reaction with compounds having at least one primary or secondary amino group and at least one hydroxyl group. This gives polyurethane dispersions which are self-crosslinking under baking conditions (at 160° C. in the examples), in other words dispersions in which one molecular contains not only hydroxyl groups but also blocked isocyanate groups, having relatively low solids contents (37% to 42% by weight in the examples) for baking enamels, especially for baking surfacers in automative finishing. In view of the low amounts of amino alcohols incorporated, the urea group contents, the functionalities relative to hydroxyl groups, and the hydroxyl group contents are low.

DE-A 10214028 describes polyurethanes for water-dilutable surfacer compositions in automotive finishing, have a solids content of greater than 50% by weight, which under baking conditions of from 140° C. meet the requirements concerning stone-chip resistance and exhibit overbake stability. It is described how such high solids contents are not achievable with water-dispersible polyurethanes containing neutralized dimethylolpropionic acid as a hydrophilicizing agent. The water-dilutable polyurethanes of the invention, having at least two free hydroxyl groups, are obtained by reaction of alkanol amines with an NCO compound to give a hydroxy-functional intermediate, followed by the addition reaction of a cyclic carboxylic anhydride with the hydroxyl groups, to form ester linkages. The carboxyl and/or carboxylate groups necessary for the dispersing of the polyurethane are therefore incorporated into the polymer via an acid anhydride. This type of acidification via anhydrides leads to the incorporation of the hydrophilicizing compound by way of monoester bonds. It is known that structures of this kind are sensitive to hydrolysis, and therefore the durability of such dispersions is very limited. In the examples, polyurethane dispersions are obtained which have solids contents of 43% to 45% by weight. High functionalities and high hydroxyl group contents are not achievable by this route, since some of the hydroxyl groups are consumed by the reaction with the acid anhydride.

DE-A 10147546 describes self-crosslinking polyurethanes in organic solution, obtained by reaction of special aliphatic-aromatic polyester, partially blocked polyisocyanate and a compound having at least two isocyanate-reactive groups, such as an amino alcohol, for example, which, when used as base coat material, are said to have advantageous properties and which possess good CAB compatibility. The polyurethanes are in solution in relatively large amounts of organic solvents and therefore no longer meet the present-day requirements in relation to emissions reduction.

DE-A 19849207 describes water-thinnable binder compositions comprising water-dilutable polyurethane urea paste resins and polyether polyols for the formulation of pigments paste for incorporation into aqueous coating compositions. The water-dilutable polyurethane urea paste resins described are reaction products of polyol, hydrophilicizing component, polyisocyanate and hydroxy amine and additionally comprise a further polyether polyol component. Suitable hydroxy-functional monoamines are amines with primary amino groups and amines with secondary amino groups. According to the disclosure, polyurethane dispersions are obtained therefrom that contain preferably organic solvents and have solids contents of up to 50%, preferably up to 42%, by weight. The polyurethane dispersions prepared in the examples have solids contents of 30% to 35% by weight and also NMP contents of approximately 6% by weight. These products therefore no longer satisfy modern-day requirements in relation to solvent content and high solids content, and, moreover, the mandatory use of polyether polyols restricts the possible uses to applications in which light fastness and weathering stability are of minor importance.

Despite the fact that the prior art concerning aqueous polyurethane dispersions is very extensive, there continues to be a great demand for improved aqueous products. Required in particular are low to zero emissions, high solids contents, high processing reliability and robustness to external influences, as for example to fluctuating levels of atmospheric humidity or low storage temperatures, high coat thicknesses achievable without defects, stability to hydrolysis, excellent film-mechanical properties, and frequently, in addition, high crosslinking densities and/or high functionalities.

A fundamental problem affecting disperse systems such as those of the kind identified above is the fact that, for actual film formation during the coating operation, the coalescence and filming of the disperse polymer particles must take place in such a way as to produce a homogeneous, optically flawless film. Owing to the complexity of the operation, this is significantly more difficult and affected by error than in a case of systems in which the film-forming polymer is in a dissolved state.

In contrast to solutions of polyurethanes in organic solvents, high-quality solutions of polyurethanes in water have been hitherto unknown.

It was an object of the present invention, therefore, to provide aqueous solutions of polyurethanes and/or polyurethane-polyureas which can have solids contents of above 50% by weight, which meet the abovementioned requirements and which are suitable for optically flawless coatings with an advantageous profile of properties.

### EMBODIMENTS OF THE INVENTION

An embodiment of the present invention is a process for preparing an aqueous solution of a hydroxy-functional polyurethane containing urea groups and having a hydroxyl group content in the range of from 2% to 10% by weight and a level of urea groups, calculated as —NH—CO—NH—, derived from amino alcohols having a primary or secondary amino group and at least one hydroxyl group in the range of from 3% to 20% by weight, based in each case on the weight of said hydroxy-functional polyurethane containing urea groups, comprising

preparing an NCO-functional prepolymer by single-stage or multi-stage reaction of
a) at least one hydroxy- and/or amino-functional hydrophilicizing agent having at least one acid group and/or the salt of an acid group, or having at least one tertiary amino group and/or the salt of a tertiary amino group;
b) at least one polyol;
c) at least one polyisocyanate; and
d) optionally, other hydroxy- and/or amino-functional compounds, different from a), b), and e);
   and reacting said NCO-functional prepolymer with
e) an amino alcohol component comprising an amino alcohol having a primary or secondary amino group and at least one hydroxyl group, wherein the fraction of amino alcohols having a secondary amino group, based on the total amount of e), is at least 60% by weight;
   and dissolving the resulting hydroxy-functional polyurethane containing urea groups in water, wherein said dissolution in water is preceded or accompanied by the reaction of the acid groups or tertiary amino groups of a) with a neutralizing agent.

Another embodiment of the present invention is the above process, wherein c) is composed of
c1) from 27% to 73% by weight of at least one difunctional isocyanate selected from the group consisting of hexamethylene diisocyanate, isophorone diisocyanate, 2,4-diisocyanatotoluene and/or 2,6-diisocyanatotoluene, and 4,4′diisocyanatodicyclohexylmethane; and
c2) from 73% to 27% by weight of at least one polyisocyanate having on average more than two isocyanate groups with uretdione, biuret, isocyanurate, allophanate, carbodiimide, iminooxadiazinedione, oxadiazinetrione, urethane, and/or urea structural units based on hexamethylene diisocyanate.

Another embodiment of the present invention is the above process, wherein component e) is an amino alcohol having exclusively one secondary amino group and one or two hydroxyl groups.

Another embodiment of the present invention is the above process, wherein said hydroxy-functional polyurethane containing urea groups is present, prior to dissolution in water, as a non-aqueous dispersion in an organic solvent.

Yet another embodiment of the present invention is an aqueous solution of a hydroxy-functional polyurethane containing urea groups obtained by the above process.

Yet another embodiment of the present invention is a polyurethane system comprising as component A) the above aqueous solution.

Another embodiment of the present invention is the above polyurethane system, wherein said polyurethane system further comprises an optionally hydrophilically modified polyisocyanate B).

Another embodiment of the present invention is the above polyurethane system, wherein B) consists of at least one hydrophobic polyisocyanate crosslinker based on hexamethylene diisocyanate.

Another embodiment of the present invention is the above aqueous solution, wherein said aqueous solution is stable to freezing.

Yet another embodiment of the present invention is a water-soluble, hydroxy-functional polyurethane containing urea groups, having a hydroxyl group content in the range of from 2% to 10% by weight and a level of urea groups, calculated as —NH—CO—NH—, derived from amino alcohols having a primary or secondary amino group and at least one hydroxyl group in the range of from 3% to 20% by weight, based in each case on the weight of said, water-soluble, hydroxy-functional polyurethane containing urea groups, obtained by preparing a NCO-functional prepolymer by reacting
a) at least one hydroxy- and/or amino-functional hydrophilicizing agent having at least one acid group and/or the salt of an acid group, or having at least one tertiary amino group and/or the salt of a tertiary amino group;
b) at least one polyol;
c) at least one polyisocyanate;
d) optionally, other hydroxy- and/or amino-functional compounds, different from a), b), and e);
   and reacting said NCO-functional prepolymer with
e) an amino alcohol component, comprising an amino alcohol having a primary or secondary amino group and at least one hydroxyl group, wherein the fraction of amino alcohols having a secondary amino group, based on the total amount of e), is at least 60% by weight;
   wherein the tertiary amino groups or acid groups in the resulting water-soluble, hydroxy-functional polyurethane containing urea groups which originate from a) are optionally present in their salt form as a result of whole or partial neutralization.

Yet another embodiment of the present invention is a polyurethane system comprising as component A) the above hydroxy-functional polyurethane containing urea groups.

Another embodiment of the present invention is the above polyurethane system, wherein said polyurethane system further comprises an optionally hydrophilically modified polyisocyanate B).

Another embodiment of the present invention is the above polyurethane system, wherein B) consists of at least one hydrophobic polyisocyanate crosslinker based on hexamethylene diisocyanate.

Yet another embodiment of the present invention is a polyurethane obtained from the above polyurethane system.

Another embodiment of the present invention is the above polyurethane, wherein said polyurethane is a paint, coating material, sealant, liquid ink, printing ink, size, adhesion promoter, or reactive diluent applied in one or more layers.

Yet another embodiment of the present invention is a substrate coated with the above polyurethane.

### DESCRIPTION OF THE INVENTION

It has now been found that aqueous polyurethane solutions and/or polyurethane-polyurea solutions having the requisite properties are obtained specifically when the polyurethanes and/or polyurethane-polyureas are synthesized using relatively high-functionality polyisocyanates, and also amino alcohols with a primary and/or secondary amino group and at least one hydroxyl group, the fraction, among amino alcohols, of those containing a secondary amino group being at least 60% by weight.

The invention therefore provides a process for preparing aqueous solutions of hydroxy-functional polyurethanes containing urea groups and having hydroxyl group contents of 2% to 10% by weight and levels of urea groups (calculated as —NH—CO—NH—) derived from amino alcohols having a primary or secondary amino group and at least one hydroxyl group of 3% to 20% by weight, based in each case on the hydroxy-functional polyurethane containing urea groups, which process comprises first preparing NCO-functional prepolymers by single-stage or multi-stage reaction of
a) at least one hydroxy- and/or amino-functional hydrophilicizing agent having at least one acid group and/or the salt of an acid group, or having at least one tertiary amino group and/or the salt of a tertiary amino group,
b) at least one polyol
c) at least one polyisocyanate
d) if desired, other hydroxy- and/or amino-functional compounds, different from the compounds of components a), b) and e)
and then reacting these prepolymers
e) with an amino alcohol component, comprising amino alcohols having a primary or secondary amino group and at least one hydroxyl group, the fraction of amino alcohols having a secondary amino group, based on the total amount of component e), being at least 60% by weight
and dissolving the resulting hydroxy-functional polyurethanes containing urea groups
f) in water, the dissolution operation in water being preceded or accompanied by the reaction of the acid groups or tertiary amino groups of the hydrophilicizing agents a) with a neutralizing agent.

The invention further provides the aqueous solutions of hydroxy-functional polyurethanes containing urea groups that are obtainable by said process.

Further provided by the invention are water-soluble hydroxy-functional polyurethanes containing urea groups, having hydroxyl group contents of 2% to 10% by weight and levels of urea groups (calculated as —NH—CO—NH—) derived from amino alcohols having a primary or secondary amino group and at least one hydroxyl group of 3% to 20% by weight, based in each case on the hydroxy-functional polyurethane containing urea groups, obtainable by preparing NCO-functional prepolymers by reacting
a) at least one hydroxy- and/or amino-functional hydrophilicizing agent having at least one acid group and/or the salt of an acid group, or having at least one tertiary amino group and/or the salt of a tertiary amino group,
b) at least one polyol
c) at least one polyisocyanate
d) if desired, other hydroxy- and/or amino-functional compounds, different from the compounds of components a), b) and e)
and reacting these prepolymers
e) with an amino alcohol component, comprising amino alcohols having a primary or secondary amino group and at least one hydroxyl group, the fraction of amino alcohols having a secondary amino group, based on the total amount of component e), being at least 60% by weight,
it being possible for the tertiary amino groups or acid groups originating from the compounds of component a), in the hydroxy-functional polyurethane containing urea groups, to be present in their salt form as a result of whole or partial neutralization.

Furthermore, polyurethane systems are provided by the invention, as is their use as coating compositions, sizes, liquid inks, printing inks and sealants.

The hydrophilicizing agents used in a) may contain carboxylic or sulfonic acid groups and/or their corresponding acid anions as the acid group for anionic hydrophilicizing. For cationic hydrophilicizing it is possible for the compounds of component a) to contain tertiary amino groups or the correspondingly protonated quaternary ammonium groups.

The compounds of component a) are used in the process of the invention typically in amounts of 0.5% to 10%, preferably 1% to 8% and more preferably 2% to 7% by weight, based on the hydroxy-functional polyurethanes containing urea groups.

Suitable hydrophilicizing agents a) are mono- and dihydroxycarboxylic acids, mono- and diaminocarboxylic acids, mono- and dihydroxysulfonic acids, mono- and diaminosulfonic acids and also mono- and dihydroxyphosphonic acids or mono- and diaminophosphonic acids and their salts, such as dimethylolpropionic acid, dimethylolbutyric acid, dimethylolacetic acid, 2,2-dimethylolpentanoic acid, dihydroxysuccinic acid, hydroxypivalic acid, N-(2-aminoethyl)alanine, 2-(2-aminoethylamino)ethanesulfonic acid, ethylenediaminepropyl- or -butylsulfonic acid, 1,2- or 1,3-propylenediamineethylsulfonic acid, malic acid, citric acid, glycolic acid, lactic acid, glycine, alanine, taurine, lysine, 3,5-diaminobenzoic acid, 6-aminohexanoic acid, 11-aminoundecanoic acid, aminoacetic acid, an adduct of IPDA, hexamethylenediamine or other diamines and acrylic acid (EP-A 0 916 647, example 1) and its alkali metal salts and/or ammonium salts; the adduct of sodium bisulfite with but-2-ene-1,4-diol, polyethersulfonate, the propoxylated adduct of 2-butenediol and NaHSO3, described for example in DE-A 2 446 440 (page 5-9, formula I-III) and/or the salts of the hydrophilicizing agents described, and also mixtures of the hydrophiticizing agents stated and, if appropriate, of other hydrophilicizing agents too.

Suitable hydrophilicizing agents a) are likewise cationic hydrophilicizing agents such as mono-, di- or trihydroxy-functional tertiary amines and mono-, di- or triamino-functional tertiary amines and their salts, such as N-methyldiethanolamine, N-ethyldiethanolamine, N-methyldiisopropanolamine, trisopropanolamine, triethanolamine, dimethylethanolamine, dimethylisopropanolamine, and the salts of the cationic hydrophilicizing agents described.

It is preferred in a) to use hydrophilicizing agents of the aforementioned kind with carboxylic or sulfonic acid groups, and/or the corresponding acid anions.

Particularly preferred hydrophilicizing agents are 2-(2-aminoethylamino)ethanesulfonic acid, the adduct of IPDA and acrylic acid (EP-A 0 916 647, example 1), dimethylolpropionic acid and hydroxypivalic acid.

Suitable polyols b) are the hydroxy-functional compounds that are known per se in polyurethane chemistry, such as

b1) polyesters,
b2) low molecular weight compounds with molecular weights of 62 to 500 g/mol,
b3) polycarbonates,
b4) C2 polyethers and/or C3 polyethers,
b5) C4 polyethers
and also hydroxy-functional epoxides, polyolefins, addition polymers, castor oil, castor oils modified in respect of functionality and/or number of double bonds, hydrocarbon resins, formaldehyde condensation products and mixtures of the aforementioned compounds.

Concerning the molecular weights of b1), b3), b4) and b5) there are no restrictions; typically the molecular weights are 500 to 20000 g/mol, preferably 500 to 12000 g/mol.

The polyols b1) to b5) can be used individually or in any desired mixtures with one another, and also, if appropriate, in mixtures with further polyols as part of b).

Polyesters b1) typically have an average functionality of 1 to 4, preferably of 1.8 to 3 and more preferably of 2. In this context it is also possible to use mixtures of different polyesters and also mixtures of polyesters with different functionalities. The molecular weights of polyesters b1) are with particular preference in the range from 700 to 5000 g/mol.

Suitable polyesters b1) can be prepared by conventional methods with elimination of water at temperatures of 100 to 260° C., if appropriate with accompanying use of typical esterification catalysts such as para-toluenesulfonic acid, dibutyltin dilaurate, HCl, tin(II) chloride, etc., preferably according to the principle of a melt condensation or azeotropic condensation, if appropriate with a vacuum being applied or with an entraining gas being used, from mono-, di-, tri- and/or tetracarboxylic acids and/or their anhydrides, mono-, di-, tri- and/or tetrafunctional alcohols and, if appropriate, lactones. In the case of an azeotropic esterification the entraining agent, typically isooctane, xylene, toluene or cyclohexane, is distilled off under reduced pressure after the end of reaction. A preferred preparation process for the polyesters b1) is a melt condensation under reduced pressure.

Suitable acids as a polyester building block may be phthalic anhydride, isophthalic acid, terephthalic acid, adipic acid, sebacic acid, suberic acid, succinic acid, maleic anhydride, fumaric acid, dimer fatty acids, tetrahydrophthalic anhydride, hexahydrophthalic anhydride, cyclohexanedicarboxylic acid, trimellitic anhydride, C8-C22 fatty acids such as 2-ethylhexanoic acid, stearic acid, oleic acid, soya oil fatty acid, peanut oil fatty acid, other unsaturated fatty acids, hydrogenated fatty acids, benzoic acid, cyclohexanecarboxylic acid and mixtures of the stated acids and also, if appropriate, of other acids.

Suitable alcohols as a polyester building block are, for example, 1,2-ethylene glycol, diethylene glycol, triethylene glycol, tetraethylene glycol, 1,2-propylene glycol, dipropylene glycol, tripropylene glycol, 1,3-propanediol, 1,3-butanediol, 1,4-butanediol, 1,6-hexanediol, neopentyl glycol, 1,4-cyclohexanedimethanol, 1,4-cyclohexanediol, butenediol, butynediol, hydrogenated bisphenols, trimethylpentanediol, 1,8-octanediol and/or tricyclodecanedimethanol, trimethylolpropane, ethoxylated trimethylolpropane, propoxylated trimethylolpropane, propoxylated glycerol, ethoxylated glycerol, glycerol, pentaerythritol, castor oil, monofunctional alcohols such as, for example, cyclohexanol, 2-ethylhexanol, polyethylene oxides, polypropylene oxides, polyethylene/propylene oxide copolymers or block copolymers, and mixtures of these and/or other alcohols.

Another suitable polyester base material is caprolactone, which can be used proportionally or else as a major component for the preparation of the polyesters b1).

Preferred polyester base materials are adipic acid, phthalic anhydride, tetrahydrophthalic anhydride, isophthalic acid, terephthalic acid, glutaric acid, soya oil fatty acid, benzoic acid, 2-ethylhexanoic acid, 1,4-butanediol, neopentyl glycol, 1,2-propylene glycol, ethylene glycol, diethylene glycol, 1,6-hexanediol, trimethylolpropane, pentaerythritol, castor oil, glycerol and mixtures thereof.

Particular preference is given to polyesters based on dicarboxylic acids which to an extent of at least 60% by weight, more preferably to an extent of 100% by weight, are aromatic in nature, more particularly phthalic anhydride, isophthalic acid, terephthalic acid.

Suitable low molecular weight polyols b2) are, for example, short-chain—that is, containing 2 to 20 carbon atoms—aliphatic, araliphatic or cycloaliphatic diols or triols. Examples of diols are ethylene glycol, diethylene glycol, triethylene glycol, tetraethylene glycol, dipropylene glycol, tripropylene glycol, 1,2-propanediol, 1,3-propanediol, 1,4-butanediol, neopentyl glycol, 2-ethyl-2-butylpropanediol, trimethylpentanediol, positionally isomeric diethyloctanediols, 1,3-butylene glycol, 1,4-cyclohexanedimethanol, 1,6-hexanediol, 1,2- and 1,4-cyclohexanediol, hydrogenated bisphenol A, (2,2-bis(4-hydroxycyclohexyl)propane), 2,2-dimethyl-3-hydroxypropyl 2,2-dimethyl-3-hydroxypropionate, trimethylolethane, trimethylolpropane or glycerol.

Preferred low molecular weight polyols b2) are diethylene glycol, ethylene glycol, butanediol, dipropylene glycol, 1,2-propanediol, neopentyl glycol, trimethylpentanediol, cyclohexanediol, 1,2 and 1,4-cyclohexanedimethanol, trimethylolpropane and glycerol.

Suitable polyols b3) are hydroxyl-terminated polycarbonates which are obtainable by reacting diols or else lactone-modified diols or else bisphenols, such as bisphenol A, for example, with phosgene or carbonic diesters such as diphenyl carbonate or dimethyl carbonate. By way of example, mention may be made of the polymeric carbonates of 1,6-hexanediol, of 1,4-butanediol, of TCD-diol, of 1,4-cyclohexanedimethanol, of 3-methyl-1,5-pentanediol, of pentanediol, of dimerdiol, of dodecanediol, of triethylene glycol, of poly-THF 650 and/or mixtures thereof, and also of the carbonates of reaction products of the stated diols with ε-caprolactone in a molar ratio of 1 to 0.1.

Preference is given to aforementioned polycarbonate diols with a number-average molecular weight of 600 to 3000 g/mol and to carbonates of reaction products of 1,6-hexane diol with ε-caprolactone in a molar ratio of 1 to 0.33.

C2 and/or C3 polyethers suitable as polyol b4) are oligomeric and polymeric reaction products of ethylene oxide and/or in the form of homopolymers, copolymers or else block (co)polymers.

The number-average molecular weights are situated preferably in the range from 500 to 6000 g/mol. The functionality of the polyethers is typically 1 to 4, preferably 2 to 3 and more preferably 2.

Suitable starter molecules or a starter molecular mixture are the known alcohols, amino alcohols and amines of the prior art, as described in Ullmanns Encyklopädie der technischen Chemie, Volume 19, 4 edition, Verlag Chemie GmbH, Weinheim, 1980, p. 31 ff.

C4 polyethers suitable as polyol b5) are oligomeric and polymeric reaction products of tetrahydrofuran in the form of homopolymers, possibly also copolymers or block (co)polymers with other monomers.

The number-average molecular weights are situated preferably in the range from 800 to 4000 g/mol. The functionality of the polyethers is typically 1 to 4, preferably 2 to 3 and more preferably 2.

Suitable starter molecules or a starter molecular mixture are, for example, the known alcohols, amino alcohols and amines of the prior art, as described for example in Ullmanns Encyklopädie der technischen Chemie, Volume 19, 4 edition, Verlag Chemie GmbH, Weinheim, 1980, p. 31 ff.

Preferred polyethers b4) and b5) are difunctional polyethers based on propylene oxide and/or tetrahydrofuran, with number-average molecular weights of 1000 to 2000 g/mol.

As further polyols it is possible to use hydroxyl-terminated polyamide alcohols, hydroxyl-terminated polyolefins based on ethylene, propylene, isoprene and/or butadiene, and hydroxyl-terminated polyacrylate diols, e.g. Tegomer® BD 1000 (Tego GmbH, Essen, DE).

Also particularly preferred is the use of a mixture of a defined polyol b2) of low molecular weight and one or two oligomeric and/or polymeric polyols based on polyester, polycarbonate and/or C3 and/or C4 polyether.

The compounds of component b) are used in the process of the invention typically in amounts of 3% to 75%, preferably 8% to 69% and more preferably 10% to 60% by weight, based on the hydroxy-functional polyurethanes containing urea groups.

Suitable components c) are any desired organic compounds which have at least two free isocyanate groups per molecule.

Suitability is possessed by diisocyantes of the general formula X(NCO)₂, where X is a divalent aliphatic hydrocarbon radical having 4 to 12 carbon atoms, a divalent cycloaliphatic hydrocarbon radical having 6 to 15 carbon atoms, a divalent aromatic hydrocarbon radical having 6 to 15 carbon atoms or a divalent araliphatic hydrocarbon radical having 7 to 15 carbon atoms.

Examples of diisocyanates of this kind are tetramethylene diisocyanate methylpentamethylene diisocyanate, hexamethylene diisocyanate, dodecamethylene diisocyanate, 1,4-diisocyanatocyclohexane, 1-isocyanato-3,3,5-trimethyl-5-isocyanatomethylcyclohexane, 4,4′-diisocyanatodicyclohexylmethane, 2,2-bis(4-isocyanatocyclohexyl)propane, 1,4-diisocyanatobenzene, 2,4-diisocyanatotoluene, 2,6-diisocyanatotoluene, 4,4′-diisocyanatodiphenylmethane, 2,2′- and 2,4′-diisocyanatodiphenylmethane, p-xylylene diisocyanate, p-isopropylidene diisocyanate, and mixtures of these compounds.

Likewise possible is the use of monomeric triisocyanates such as 4-isocyanatomethyl-1,8-octane diisocyanate (nonane triisocyanate).

Also suitable as well as the aforementioned monomeric isocyanates are the higher molecular weight derivatives of these monomeric isocyanates that are known per se, having uretdione, isocyanurate, urethane, allophanate, biuret, carbodiimide, iminooxadiazinedione and/or oxadiazinetrione structure, as are obtainable in a conventional manner through modification of simple aliphatic, cycloaliphatic, araliphatic and/or aromatic diisocyanates.

The polyisocyanates used in c) are based preferably on hexamethylene diisocyanate, isophorone diisocyanate, 4,4′-diisocyanatodicyclohexylmethane, 1-methyl-2,4-diisocyanatocyclohexane, 1-methyl-2,6-diisocyanatocyclohexane, 2,4-diisocyanatotoluene and/or 2,6-diisocyanatotoluene.

In c) it is particular preferred to use a polyisocyanate component which comprises at least one polyisocyanate having on average more than two isocyanate groups and which may further comprise monomeric diisocyanates.

Preferred components among these polyisocyanate components c) are those composed of

c1) 0% to 95% by weight of at least one difunctional isocyanate from the group consisting of hexamethylene diisocyanate, isophorone diisocyanate, 4,4′-diisocyanatodicyclohexylmethane, 1-methyl-2,4-diisocyanatocyclohexane, 1-methyl-2,6-diisocyanatocyclohexane, 2,4-diisocyanatotoluene and/or 2,6-diisocyanatotoluene and
c2) 5% to 100% by weight of at least one polyisocyanate having on average more than two isocyanate groups with uretdione, biuret, isocyanurate, allophanate, carbodiimide, iminooxadiazinedione, oxadiazinetrione, urethane and/or urea structural units.

With particular preference the polyisocyanate component used in c) is composed of

c1) 27% to 73% by weight of at least one difunctional isocyanate selected from the group consisting of hexamethylene diisocyanate, isophorone diisocyanate, 2,4-diisocyanatotoluene and/or 2,6-diisocyanatotoluene and 4,4′-diisocyanatodicyclohexylmethane and
c2) 73% to 27% by weight of at least one polyisocyanate having on average more than two isocyanate groups with uretdione, biuret, isocyanurate, allophanate, carbodiimide, iminooxadiazinedione, oxadiazinetrione, urethane and/or urea structural units based on hexamethylene diisocyanate.

The compounds of component c) are used in the process of the invention typically in amounts of 19 to 70%, preferably 22% to 65% and more preferably 24% to 60%, by weight, based on the hydroxy-functional polyurethanes containing urea groups.

Suitable compounds of component d), where appropriate for accompanying use, may be as follows: further hydrophilic components such as mono- or dihydroxy-functional polyethers such as mono- and/or di-hydroxy-functional ethylene oxide polyethers, mono- and/or dihydroxy-functional propylene oxide/ethylene oxide copolyethers and/or mono- and/or dihydroxy-functional propylene oxide/ethylene oxide block polyethers of the molecular weight range 200 to 3000 g/mol, hydrazide compounds such as hydrazine or adipic dihydrazide, diamines such as ethylenediamine, 1,3-propylenediamine, 1,6-hexamethylenediamine, isophoronediamine, 1,3-, 1,4-phenylenediamine, 4,4′-diphenylmethanediamine, 4,4′-dicyclohexylmethanediamine, amino-functional polyethylene oxides or polypropylene oxides, which are obtainable under the name Jeffamin®, D series (Huntsman Corp. Europe, Belgium), and also triamines such as diethylenetriamine, monoamines, such as butylamine, ethylamine and amines of the Jeffamin® M series (Huntsman Corp. Europe, Belgium), amino-functional polyethylene oxides and polypropylene oxides; likewise suitable, albeit less preferably, are monofunctional alcohols as ethanol, propanol, isopropanol, butanol, sec-butanol, tert-butanol, pentanol, hexanol, octanol, butyl glycol, butyl diglycol, methyl glycol, methyl diglycol, ethyl glycol, ethyl diglycol, methoxy glycol, methoxy diglycol, methoxy triglycol, methoxypropanol, cyclohexanol, 2-ethylhexanol; likewise suitable may be C9-C22 alcohols, which if appropriate may also contain double bonds, such as stearyl alcohol, oleyl alcohol; vinyl alcohol, hydroxyethyl (meth)acrylate, hydroxypropyl (meth)acrylate, hydroxybutyl (meth)acrylate; thiols and other NCO-reactive compounds, and mixtures of the exemplified components d) and of other compounds too.

If components d) are used, then it is preferably the polyether-based hydrophilic compounds exemplified above.

The compounds of component d) are used in amounts of typically 0% to 25%, preferably 0% to 10%, more preferably 0% to 3.5%, by weight, based on the hydroxy-functional polyurethanes containing urea groups.

Compounds of component e) that are suitable in principle are amino alcohols having exclusively one primary or exclusively one secondary amino group and at least one hydroxyl group, such as diethanolamine, N-methylethanolamine, N-ethylethanolamine, N-propylethanolamine, diisopropanolamine, N-methylisopropanolamine, N-ethylisopropanolamine, N-propylisopropanolamine, N-hydroxyethylaminocyclohexane, N-hydroxyethylaminobenzene, reaction products of monoepoxides such as, for example, Cardura® E10 [glycidyl ester of Versatic acid, Hexion] with primary or secondary monoamines such as ammonia, ethylamine, propylamine, butylamine, hexylamine, cyclohexylamine or amino alcohols having primary amino groups such as ethanolamine, isopropanolamine, propanolamine, reaction products of unsaturated compounds such as hydroxyethyl acrylate, hydroxypropyl acrylate, hydroxybutyl acrylate, hydroxyethyl methacrylate, hydroxypropyl methacrylate or hydroxybutyl methacrylate in the sense of a Michael addition with primary or secondary amines or with amino alcohols having primary amino groups such as ammonia, ethylamine, propylamine, butylamine, hexylamine, cyclohexylamine, ethanolamine, isopropanolamine, propanolamine, with component e) being composed to an extent of at least 60% by weight of amino alcohols having secondary amine groups.

In component e) it is preferred to use at least 80% by weight of amino alcohols having a secondary amino group and 1 to 3 hydroxyl groups.

With particular preference use is made in component e) exclusively, i.e. to an extent of 100% by weight, of amino alcohols having exclusively one secondary amino group and one or two hydroxyl groups, such as diethanolamine, N-methylethanolamine, N-ethylethanolamine, diisopropanolamine, N-methylisopropanolamine, N-ethylisopropanolamine.

The compounds of component e) are used typically in amounts of 0.7% to 1.2%, preferably of 0.93% to 1.03% and more preferably in amounts of 0.96 to 1.0 equivalent of amino groups of the compounds of component e) to equivalents of isocyanate groups of the prepolymer, obtained by reacting components a), b), c) and, if appropriate, d), in order to obtain conversion of the amino groups with the isocyanate groups, to form urea structures, that is as targeted as possible.

The reaction of the NCO-functional intermediate formed from the components a), b), c) and, if appropriate, d) with the hydroxyamine component e), this reaction being essential to the invention, leads to the formation of urea structures.

For the preparation of the hydroxy-functional polyurethanes containing urea groups of the invention, and/or of their solutions, the constituents a), b), c) and, if appropriate, d) are reacted in a single-stage or, if appropriate, multi-stage synthesis, if appropriate with accompanying use of catalyst(s), to give an isocyanate-functional intermediate, followed by reaction with component e) until the desired isocyanate content has been reached, generally <0.5%, preferably <0.1%, by weight. In the case of solutions, this is followed by the dissolution of the hydroxy-functional polyurethanes containing urea groups in or with water, a sufficient amount of suitable neutralizing agent being added at any desired point in time before or parallel with the dissolution, and any solvent used being distilled off again in whole or in part.

The isocyanate-functional intermediate is prepared either in bulk at 20 to 170° C. or in organic solution at temperatures of 20 to 200, preferably 40 to 90° C. by a single-stage or multi-stage reaction of components a), b), c) and, if appropriate, d) until the isocyanate content is at approximately, or just below, the theoretical or desired isocyanate content, and this is followed by the reaction of this isocyanate-functional intermediate with component e), preferably such that component e), diluted if appropriate with a solvent, is introduced at 0 to 50° C. and the isocyanate-functional intermediate, in solution if appropriate, is metered in at a rate such that the exothermic reaction remains controllable at every point in time. The amount of component e) in this case is preferably such that one amino group of an amino alcohol is used for each free isocyanate group of the intermediate. The reaction is then carried out until the isocyanate content of the reaction product has reached the desired value, generally <0.5%, preferably <0.1%, more preferably 0%, by weight.

The neutralizing agents that are needed in order to convert the acid groups of the compounds of component a) may be used during the actual preparation of the isocyanate-functional intermediate, if the neutralizing agents do not contain isocyanate-functional groups. Suitable in principle for this purpose are all amines which contain: no primary or secondary amino group and no hydroxyl group, such as triethylamine, N-methylmorpholine, dimethylcyclohexylamine, ethyldiisopropylamine, dimethylisopropylamine, and mixtures of these and of other corresponding amines as well.

If appropriate it is necessary to bear in mind that excessive amounts of such neutralizing agents may lead during the reaction to unwanted secondary reactions, such as an excessive trimerization of the compounds of component c). Therefore the neutralizing agents exemplified are preferably not added until after the preparation of the isocyanate-functional intermediate.

It is particularly preferred to add the neutralizing agents after the reaction of the isocyanate-functional intermediates with the amino alcohol component e), either before dissolution with/in water or in parallel thereto, as for example through the use of a water/neutralizing agent mixture for the dissolution step.

Here it is also possible, as well as the amines already stated, to use other bases, which contain, for example, free amino and/or hydroxyl groups, such as, for example, ammonia, 2-aminoethanol, aminopropanols, 3-amino-1,2-propanediol, aminobutanols, 1,3-diamino-2-propanol, bis(2-hydroxypropyl)amine, triethanolamine, N-methyldiethanolamine, N-methyldiisopropanolamine, dimethylethanolamine, diethylethanolamine, dimethylisopropanolamine, morpholine, 2-aminomethyl-2-methylpropanol and also sodium hydroxide, lithium hydroxide, barium hydroxide, potassium hydroxide and also mixtures of the stated neutralizing agents and also, if appropriate, of other neutralizing agents.

Preferred neutralizing agents are ammonia, triethylamine, dimethylethanolamine, methyldiethanolamine, triethanolamine, 2-aminomethyl-2-methylpropanol, dimethylcyclohexylamine, ethyldiisopropylamine, lithium hydroxide, sodium hydroxide, potassium hydroxide and mixtures thereof.

The amount of neutralizing agent added overall is such that an optically clear to slightly opaque aqueous solution is obtained. Typically the degree of neutralization, based on acid groups incorporated, is at least 25 mol %, preferably at least 50 mol % and not more than 150 mol %. With a degree of neutralization of more than 100 mol %, as well as 100% of ionic salt groups, there is also then additional free neutralizing agent present. Particular preference is given to a degree of neutralization of 50 to 100 mol %.

It is also possible to use mixtures and/or combinations of different neutralizing agents.

In the case of cationic aqueous polyurethane solutions, the tertiary amino groups incorporated are converted with acid into the corresponding salts. Suitable in principle for this purpose are all acids, preference being given to phosphoric acid, lactic acid and acetic acid.

Suitable catalysts for preparing the hydroxy-functional polyurethanes containing urea groups that are essential to the invention are, for example, the catalysts that are known in isocyanate chemistry, such as tertiary amines, compounds of tin, of zinc, of titanium, of zirconium, of molybdenum or of bismuth, especially triethylamine, 1,4-diazabicyclo[2,2,2]octane, tin dioctoate or dibutyltin dilaurate. The catalysts may be used in amounts of 0% to 2% by weight, preferably of 0% to 0.5% by weight, based on the total amount of all the compounds used for polyurethane preparation.

The dissolution in water of the hydroxyl-functional polyurethanes containing urea groups is accomplished either by addition of water, heated if appropriate, with stirring to the polyurethane, if appropriate in solution in organic solvents, or else by transfer of the polyurethane, containing organic solvents if appropriate, to an aqueous receiver vessel, with stirring.

Examples of suitable solvents are acetone, methyl ethyl ketone, methyl isobutyl ketone, Ne-methylpyrrolidone, N-ethylpyrrolidone, butyl glycol, butyl diglycol, ethylene glycol dimethyl ether, ethylene glycol, propylene glycol, dipropylene glycol, methoxypropanol, methoxypropyl acetate and mixtures of the stated solvents and of other solvents too. Proportionally it is also possible to use hydrophobic solvents as well, such as aliphatic and/or aromatic hydrocarbons and/or hydrocarbon mixtures such as solvent naphtha, toluene, etc. A preferred solvent used is acetone.

The aqueous polyurethane solutions of the invention contain typically less than 20% by weight, preferably less than 5% by weight, of organic solvents, dispersents and diluents. Particular preference is given to virtually solvent-free aqueous solutions, which generally then contain less than 1% by weight of solvent.

The organic solvents used for the preparation, especially the preferred acetone, are frequently unable to dissolve the polyurethanes of the invention. In general an intermediate is obtained which is a non-aqueous dispersion of the polyurethane of the invention in the organic medium, in particular in acetone. This has the advantage that the viscosity prior to the dispersing step is particularly low and the dispersion is made easier.

The preparation of the aqueous polyurethane solutions of the invention via a non-aqueous, organic dispersion, preferably in acetone, as an intermediate is a preferred preparation process for the aqueous polyurethanes of the invention and their solutions.

Following dissolution in/with water, the solvent, where present, is removed partly, preferably wholly, by distillation, as for example by application of a gentle vacuum or by blowing off with a stream of nitrogen. In this context it is also possible to remove excess water by distillation as well as to increase further the solids content of the solutions.

Before, during or after the dissolution step f) it is possible if desired to add additives, auxiliaries, solvents or, again, neutralizing agents, such as surface-active substances, emulsifiers, stabilizers, anti-settling agents, UV stabilizers, catalysts for the crosslinking reaction, photoinitiators, initiators, defoamers, antioxidants, anti-skinning agents, flow control assistants, thickeners and/or bactericides.

In this way, visually clear, or else, if appropriate, slightly opaque, aqueous solutions are obtained of hydroxy-functional polyurethanes containing urea groups, with high solids contents, little or no fractions of organic solvents, excellent stability to hydrolysis even on prolonged storage, dilution characteristics and processing characteristics like those of organically dissolved polymers, which for diverse possible applications are outstandingly suitable. On the basis of the high solids contents and the character of the solution it is possible, for example, in one operation to obtain films having a particularly high, defect-free, smooth and very even coat thickness in the case of coating materials or adhesives, since, in contrast to the use of dispersions, there is no need for coalescence of dispersion particles and the solids contents is higher than is usual in the case of dispersions.

The aqueous polyurethane solutions of the invention typically have solids contents of 30% to 80%, preferably 46% to 75% and more preferably 55% to 75%, by weight.

The hydroxy-functional polyurethanes and/or polyurethane-polyureas, containing urea groups, and/or their solutions, according to the invention, have polyurethane molecular weights, determined arithmetically in accordance with the formula below, of 750 to 30000 g/mol preferably of 850 to 7500 g/mol and more preferably of 1000 to 3000 g/mol.

The molecular weight can be determined arithmetically in accordance with the following formula:

MG=mass of batch/(mol of isocyanates c)+mol of hydrophilicizing agents a)+mol of polyols b)+mol of amino alcohols d)+mol of other compounds e))−equivalents of isocyanate groups=g/mol.

The hydroxy-functional polyurethanes containing urea groups of the invention, and their solutions, preferably have hydroxyl group contents of 2.5% to 9% by weight, more preferably 3% to 7.5% by weight, based on the solids content of the solution, it being possible for the OH groups to be primary and/or secondary in nature. Primary hydroxyl groups are preferred.

The acid number of the hydroxy-functional polyurethanes containing urea groups according to the invention, and their solutions, is preferably 2 to 45 mg/KOH/g, preferably 4 to 28 mg KOH/g and more preferably 6 to 17 mg KOH/g, based on the polyurethane.

The hydroxy-functional polyurethanes containing urea groups according to the invention, and their solutions, contain urea group contents, generated via the amino group of component e), of 3% to 20%, preferably 5% to 17% and very preferably 8% to 14% by weight, based on the polyurethanes; it is possible for further urea groups, as for example through the use of polyisocyanate components c) containing urea groups and/or through the use of amines as component d), and/or through the use of amino-functional hydrophilicizing agents a), to be incorporated into the aqueous solutions of the polyurethanes and/or into the polyurethanes themselves.

The aqueous polyurethane solutions of the invention are aqueous solutions having an average particle size of <200 nm, preferably clear or opaque solutions having an average particle size of <50 nm, and more preferably optically clear solutions, for which in general it is no longer possible to determine particle sizes.

The hydroxy-functional polyurethanes of the invention containing urea groups, and their solutions, can themselves be used alone or in combination with other aqueous solutions and/or dispersions, if appropriate with addition of crosslinkers that react with OH groups, in polyurethane systems.

Additionally provided by the invention, furthermore, are polyurethane systems comprising as component A) the hydroxy-functional polyurethanes containing urea groups of the invention, or their aqueous solutions.

As component B) it is possible for the polyurethane systems of the invention to comprise polyisocyanates B), which if appropriate are hydrophilically modified.

Such hydrophilically modified water-dispersible or water-soluble polyisocyanates can be obtained by reaction of
B1) at least one polyisocyanate having aliphatically, cycloaliphatically, araliphatically and/or aromatically attached isocyanate groups,
B2) at least one ionic or potentially ionic and/or nonionic hydrophilicizing compound,
B3) if appropriate, one or more polyfunctional alcohols and/or polyols and/or amino alcohols and/or polyamines having 1 to 4 hydroxyl groups, of the molecular weight range 62 to 2500 g/mol.

Polyisocyanates B) that are suitable for use in B) and may have been hydrophilically modified may comprise, if appropriate, stabilizers, emulsifiers and other auxiliaries and also, if appropriate, solvents.

The water-dispersible or water-soluble polyisocyanates are preferably constructed from

30% to 98%, preferably 50% to 97%, more preferably 70% to 96% by weight of component B1),
1% to 40%, preferably 2% to 35%, more preferably 3% to 20% by weight of component B2),
0% to 60%, preferably 0% to 45%, more preferably 0% to 30% by weight of component B3).

The water-dispersible or water-soluble polyisocyanates B) may be used in the coating compositions of the invention as 100% substance or as an organic solution or dispersion. The solution or dispersion of the polyisocyanates has a solids content of 10% to 98%, preferably of 50% to 95%, by weight.

Suitable polyisocyanates B1) for preparing the water-dispersible or water-soluble polyisocyanates B) are the polyisocyanates which are prepared by modifying simple aliphatic, cycloaliphatic, arylaliphatic and/or aromatic diisocyanates, of the type specified above for the description of component c), said polyisocyanates having uretdione, isocyanurate, allophanate, biuret, urea, urethane, iminooxadiazinedione and/or oxadiazinetrione structures, of the kind described for example in J. Prakt. Chem. 336 (1994) page 185-200.

The water-dispersible or water-soluble polyisocyanates B) are prepared preferably on the basis of aliphatic and/or cycloaliphatic diisocyanates, more preferably on the basis of hexamethylene diisocyanate.

Examples of suitable hydrophilicizing components B2) are polyoxyalkylene ethers which contain at least one hydroxy or amino group. These polyethers include a fraction of 30% to 100% by weight of building blocks derived from ethylene oxide. Suitability is possessed by polyethers which are of linear construction and have a functionality of between 1 and 3, but also by compounds of the general formula (I),

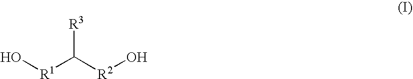

in which
R¹ and R² independently of one another are each a divalent aliphatic, cycloaliphatic or aromatic radical having 1 to 18 carbon atoms, which may be interrupted by oxygen and/or nitrogen atoms, and
R³ is an alkoxy-terminated polyethylene oxide radical.

Further examples of nonionically hydrophilicizing compounds are monofunctional polyalkylene oxide polyether alcohols which contain on average 5 to 70, preferably 7 to 55, ethylene oxide units per molecule, of the kind obtainable in conventional manner by alkoxylation of suitable starter molecules (e.g. in Ullmanns Encyclopädie der technischen Chemie, 4th edition, Volume 19, Verlag Chemie, Weinheim pp. 31-38).

Examples of suitable starter molecules are saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers such as, for example, diethylene glycol monobutyl ether, unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol, secondary monoamines such as dimethylamine, diethylamine, dipropylamine, diisopropylamine, dibutylamine, bis(2-ethylhexyl)amine, N-methyl- and N-ethylcyclohexylamine or dicyclohexylamine, and also heterocyclic secondary amines such as morpholine, pyrrolidine, piperidine or 1H-pyrazole. Preferred starter molecules are saturated monoalcohols. Particular preference is given to using diethylene glycol monobutyl ether, ethylene glycol monoalkyl ethers, diethylene glycol monomethyl ether and/or diethylene glycol monoethyl ether as a starter molecule.

Alkylene oxides suitable for the alkoxylation reaction are, in particular, ethylene oxide and propylene oxide, which can be used in any order or else in a mixture in the alkoxylation reaction.

The polyalkylene oxide polyether alcohols are either pure polyethylene oxide polyethers or mixed polyalkylene oxide polyethers at least 30 mol %, preferably at least 40 mol %, of whose alkylene oxide units are composed of ethylene oxide units. Preferred nonionic compounds are monofunctional mixed polyalkylene oxide polyethers containing at least 40 mol % ethylene oxide units and not more than 60 mol % propylene oxide units.

Suitable ionic or potentially ionic compounds B2) are, for example, mono- and dihydroxycarboxylic acids, mono- and diaminocarboxylic acids, mono- and dihydroxysulfonic acids, mono- and diaminosulfonic acids and their salts, such as dimethylolpropionic acid, dimethylolbutyric acid, hydroxypivalic acid, N-(2-aminoethyl)-β-alanine, 2-(2-aminoethylamino)ethanesulfonic acid, ethylenediaminepropyl- or -butylsulfonic acid, 1,2- or 1,3-propylenediammethylsulfonic acid, malic acid, citric acid, glycolic acid, lactic acid, glycine, alanine, taurine, lysine, 3,5-diaminobenzoic acid, an adduct of IPDI and acrylic acid (EP-A 0 916 647, example 1) and its alkali metal and/or ammonium salts; the adduct of sodium bisulfite with but-2-ene-1,4-diol, polyethersulfonate, the propoxylated adduct of 2-butenediol and NaHSO3, described for example in DE-A 2 446 440 (page 5-9, formula I-III and cyclohexylaminopropanesulfonic acid. Preferred ionic or potential ionic compounds are those which possess sulfonate groups, incorporated in particular through cyclohexylaminopropanesulfonic acid.

Likewise suitable is the combination of different hydrophilicizing components B2), for example nonionic, polyethylene oxide-based components and ionic, sulfonate-based components.

The ionic and nonionic hydrophilicizing components B2) exemplified are reacted, by reaction of their hydroxyl and/or amino groups, with some of the isocyanate groups of the polyisocyanates. This case is also referred to as internal, chemically incorporated hydrophilicization.

The preparation of water-dispersible polyisocyanates of this kind is comprehensively elucidated in, for example, EP-A 0 959 087 (page 2, lines 2546) and EP-A 1 065 228 (page 4 line 43 to page 10 line 35).

Internal emulsifiers B2) that are likewise suitable are the ionically hydrophilicized, water-emulsifiable polyisocyanates that are described in EP-A 0 703 255 and that comprise, as emulsifiers, reaction products of polyisocyanate and any hydroxy-, mercapto- or amino-functional compounds having at least one sulfuric acid group or its anion. Preferred sulfuric-acid synthesis components for preparing the emulsifiers are hydroxy sulfonic acids having aliphatically attached OH groups, or the salts of such hydroxysulfonic acids, examples being specific polyethersulfonates of the kind traded, for example, under the name Tegomer® (Th. Goldschmidt AG, Essen, DE), bisulfite adducts with unsaturated alcohols, hydroxyethane sulfonic and hydroxypropanesulfonic acids, and aminosulfobetanes, which can be prepared by quaternizing tertiary amino alcohols with 1,3-propane sulfone. Preference is also given to 2-(cyclohexylamino)ethanesulfonic acid and 3-(cyclohexylamino)propanesulfonic acid or salts thereof as hydrophilicizing components.

Suitable external emulsifiers as constituent B2) are, for example, anionic emulsifiers, such as those that are alkyl sulfate-based, Alkylarylsulfonates, allylphenol polyether sulfates as specified for example in Houben-Weyl, Methoden der organischen Chemie, Additional and Supplementary Volumes, 4th edition, Volume E 20, 1987 (part 1, pages 259 to 262), or alkyl polyether sulfates, or nonionic emulsifiers, such as the alkoxylation products, preferably ethoxylation products, of alkanols, phenols or fatty acids, for example.

Suitable components B3) for accompanying use if appropriate may be the following:

Monofunctional C1 to C22 alcohols, such as butanol or 2-ethylhexanol, for example, diols with a molecular weight of 62 to 350, such as butanediol, diethylene glycol, neopentyl glycol, ethylene glycol, for example, triols such as trimethylolpropane, glycerol, di- or tri-hydroxy-functional C2, C3 and/or C4 polyethers and/or polyesters and/or polycarbonates with a molecular weight of 400 to 2500 g/mol, monofunctional amines, diamines such as hexamethylenediamine and hydroxy amines.

The polyisocyanate crosslinkers B) have an NCO content of 1% to 50% by weight, preferably of 8% to 30% by weight. They may where appropriate be diluted with a solvent which is miscible with water if appropriate but that is inert towards isocyanates.

As polyisocyanate crosslinkers B) it is likewise possible to employ hydrophobic polyisocyanates, i.e. not hydrophilically modified polyisocyanates, of the kind described above as component B1) or as reaction products of B1) with B3). Such hydrophobic polyisocyanates typically have a viscosity of 100 to 10000 mPas/23° C.

Preferred hydrophobic polyisocyanates are those having a viscosity of 500 to 5000 mPas/23° C.

Preference is given to hydrophobic polyisocyanates of the aforementioned kind with isocyanurate, biuret, uretdione, iminooxadiazinedione, urethane, urea and/or allophanate structural units, based on (cyclo)aliphatic diisocyanates, especially those based on hexamethylene diisocyanate.

Preference is given to aforementioned hydrophobic polyisocyanates having a functionality of >2, in particular of >2.8.

In one preferred embodiment of the invention the polyurethane systems of the invention comprise

A) at least one hydroxy-functional polyurethane of the invention containing urea groups, or its aqueous solution, together if appropriate with other aqueous solutions and/or dispersions and/or organically dissolved or dispersed polymers and/or oligomers and/or 100% products, and
B) at least one polyisocyanate crosslinker composed to an extent of at least 75% by weight of hydrophobic polyisocyanate crosslinkers.

In one particularly preferred embodiment of the invention the polyurethane systems of the invention comprise

A) at least one hydroxy-functional polyurethane of the invention containing urea groups, or its aqueous solution, together if appropriate with other aqueous solutions and/or dispersions and/or organically dissolved or dispersed polymers and/or oligomers and/or 100% products of the aforementioned kind, and
B) at least one polyisocyanate crosslinker composed to an extent of 100% by weight of hydrophobic polyisocyanate crosslinkers and based on hexamethylene diisocyanate.

It will be appreciated that mixtures of different polyisocyanates B) can also be used, especially mixtures of a hydrophilicized polyisocyanate and a non-hydrophilicized polyisocyanate, or mixtures of a low-viscosity, non-hydrophilicized polyisocyanate of low functionality with a non-hydrophilicized polyisocyanate of higher viscosity and higher functionality. By means of such preferred combinations it is possible to set optimum hydrophilicity, i.e. very low hydrophilicity, in component B) and to set an optimum mixing behaviour.

Furthermore, in the polyurethane systems of the invention, there may also be further solutions or dispersions C) present, such as, for example, dispersions containing unsaturated groups, such as dispersions containing unsaturated polymerizable groups and based on polyester, polyurethane, polyepoxide, polyether, polyamide, polysiloxane, polycarbonate, epoxy acrylate, addition polymer, polyester acrylate, polyurethane-polyacrylate and/or polyacrylate.

In C) it is also possible for dispersions based, for example, on polyesters, polyurethanes, polyepoxides, polyethers, polyamides, polyvinyl esters, polyvinyl ethers, polysiloxanes, polycarbonates, addition polymers and/or polyacrylates to be admixed that likewise contain functional groups such as hydroxyl groups, for example. Therefore it is possible for example to combine two different hydroxy-functional aqueous polymers, for example to combine the relatively low molecular weight aqueous polyurethane solutions of the invention, having relatively high hydroxyl group contents, with relatively high molecular weight polymer dispersions based, for example, on polyacrylate and/or polyurethane and having relatively low hydroxyl group contents, and so to generate special effects, examples being segmentation, interpenetrating networks, etc.

In C) it is also possible to admix dispersions which are based on polyesters, polyurethanes, polyepoxides, polyethers, polyamides, polysiloxanes, polyvinyl ethers, polybutadienes, polyisoprenes, chlorinated rubbers, polycarbonates, polyvinyl esters, polyvinyl chlorides, addition polymers, polyacrylates, polyurethane-polyacrylate, polyester acrylate, polyether acrylate, alkyd, polycarbonate, polyepoxide, epoxy acrylate and that contain no functional groups. In this way it is possible, for example, to reduce the degree of the crosslinking density, to influence the physical drying, such as to accelerate it, for example, or to bring about elasticization or an adaptation of adhesion.

Likewise in C) it is possible to use what are called reactive diluents, low-viscosity compounds with unsaturated groups, such as hexanediol bisacrylate, trimethylolpropane trisacrylate, trimethylolpropane diacrylate, pentaerythritol tetraacrylate, dipentaerythritol hexaacrylate, and diepoxide bisacrylate based on bisphenol A.

The polyurethane systems of the invention may further comprise diverse additives and adjuvants, such as stabilizers, initiators, photoinitiators, antioxidents, flow control agents, peroxides, hydroperoxides, defoamers, siccatives, wetting agents, accelerators and/or light stabilizers, for example.

In addition they may comprise organic and/or inorganic pigments and/or metallic pigments based on aluminium flakes; fillers such as, for example, carbon black, silica, talc, kaolin, glass in the form of powder or of fibres, cellulose and mixtures of these and/or other additives, auxiliaries and other materials that are customary in the production of paints, coatings and adhesives.

Owing to the free reactive groups, the polyurethane systems of the invention have a limited processing time of a few minutes up to 24 hours, or longer in exceptional cases.

The ultimate properties of these reactive polyurethane systems, the cure rate and also the processing time (pot life), can be influenced by methods which include the addition of catalysts. Suitable catalysts are, for example tertiary amines such as diazabicyclononane, for example; diazabicycloundecane, triethylamine, ethyldiisopropylamine, metal compounds based on tin, such as tin(II) octoate, dibutyltin dilaurate and tin chloride, for example, based on zinc, magnesium, zirconium or bismuth, or on molybdenum, such as lithium molybdate, for example, and also on other metals. Typical amounts for use are 0.001% to 1% by weight, based on the solids content of the formulation.

With the polyurethane systems of the invention it is possible in principle to subject all substrates to painting, coating, refinement, impregnation and/or treatment, such as, for example, mineral substrates, wood, wood-based materials, furniture, wood-block flooring, doors, window frames, metallic articles, plastics, paper, paper board, cork, leather, synthetic leather, textiles, ceramic materials and composite materials of all kinds.

They are suitable as coating compositions, sealants, liquid inks, printing inks, sizes, adhesion promoters and reactive diluents.

The polyurethane systems may be applied in a known way, by spraying, knife coating, rolling, roller coating, spreading, dipping or pouring.

In this way it is possible to obtain coating materials and coatings which are distinguished by very good processing properties, robustness and also freeze stability and are distinguished to coatings having excellent film optical qualities, fullness and evenness, low susceptibility to craters, good resistance properties, and a balanced hardness/elasticity level.

The polyurethane systems of the invention can be cured at ambient temperature up to 200° C., preferably at 10 to 80° C.

The polyurethane systems of the invention are produced by mixing the aqueous solution essential to the invention, where appropriate in combination with further aqueous or else organically dissolved or dispersed polymers and/or oligomers and/or 100% products, with one or more of the crosslinker resins described and also, if appropriate, further crosslinker resins. This mixing operation may take place in one stage or in a multiplicity of stages, by stirring by hand or else by using technical assistants or machines which generate an increased shearing action and so produce particularly homogeneous mixing. Suitable mixing methods and mixing assemblies are, for example, nozzle-et dispersing, dispersing by means of dissolvers, by means of forced mixing assemblies, by means of ball mills or bead mills, or by means of static mixers.

In order to obtain particular effects it is also possible during production to add the required amounts of auxiliaries that are typical in the coatings industry, such as surface-active substances, emulsifiers, stabilizers, anti-settling agents, UV stabilizers, slip additives, matting agents, catalysts for the crosslinking reaction, defoamers, antioxidants, anti-settling agents, wetting agents, plasticizers, anti-skinning agents, flow control assistants, thickeners and/or bactericides.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

Unless indicated otherwise, all percentages are to be understood as percent by weight.

The stated viscosities were measured in accordance with DIN 53229 at 23° C.

The stated NCO contents were determined in accordance with DIN EN ISO 11909.

The stated solids contents were determined in accordance with DIN EN ISO 3251.

Raw materials used:

Desmophen® C 2200 (Bayer MaterialScience AG, Leverkusen, Germany), aliphatic polycarbonate diol with hydroxyl end groups, molecular weight 2000 g/mol, OH number 56 mg KOH/g solids

Desmodur® N 3300 (Bayer MaterialScience AG, Leverkusen, Germany), solvent-free aliphatic polyisocyanate with isocyanurate structural units, based on hexamethylene diisocyanate, equivalent weight 195 g/mol

Desmodur® N 100 (Bayer MaterialScience AG, Leverkusen, Germany), solvent-free aliphatic polyisocyanate with biuret structural units, based on hexamethylene diisocyanate, equivalent weight 190 g/mol

Desmodur® N 3400 (Bayer MaterialScience AG, Leverkusen, Germany), solvent-free aliphatic polyisocyanate with uretdione structural units, based on hexamethylene diisocyanate, equivalent weight 191 g/mol

Desmodur® Z4400 (Bayer MaterialScience AG, Leverkusen, Germany), solvent-free aliphatic polyisocyanate with isocyanurate structural units, based on isophorone diisocyanate, equivalent weight 252 g/mol

Desmodur® 44M (Bayer MaterialScience AG, Leverkusen, Germany), monomeric diphenylmethane 4,4′-diisocyanate, equivalent weight 125 g/mol

Desmophen® 2028 (Bayer MaterialScience AG, Leverkusen, Germany), polyester diol based on adipic acid, 1,6-hexanediol and neopentyl glycol, with hydroxyl end groups, molecular weight 2000, OH number 56 mg KOH/g solids

Desmophen® 3600 (Bayer MaterialScience AG, Leverkusen, Germany); polypropylene oxide diol, with hydroxyl end groups, molecular weight 2000 g/mol, OH number 56 mg KOH/G solids

Polyether LP 112 (Bayer MaterialScience AG, Leverkusen, Germany); polypropylene oxide diol, with hydroxyl end groups, molecular weight 1000 g/mol, OH number 112 mg KOH/G solids

Polyester P200H (Bayer MaterialScience AG, Leverkusen, Germany); polyester diol based on phthalic anhydride and 1,6-hexanediol, with hydroxyl end groups, molecular weight 2000 g/mol, OH number 56 mg KOH/G solids

MPEG 750: Methoxypolyethylene glycol, molecular weight 750 g/mol (e.g. Pluriol® 750, BASF AG, Germany)

Terathane® 2000 (Invista, USA), hydroxy-functional polytetramethylene glycol, “Poly THF”, molecular weight 2000 g/mol

### Polyurethane Solution 1)

A mixture of 8.5 g of butanediol, 270 g of polyester P200H and 41.6 g of dimethylolpropionic acid was diluted with 349 g of acetone and admixed at 40° C. with a mixture of 179.8 g of isophorone diisocyanate and 315.9 g of Desmodur® N 3300. It was stirred at 60° C. until the theoretical NCO content reached, or fell slightly below, 7.8%. This isocyanate-functional intermediate solution was diluted with 320 g of acetone and then incorporated with stirring into an initial charge mixture, introduced at room temperature, of 162 g of N-methylethanolamine and 148 g of acetone, the resulting mixture being stirred at 50° C. until the NCO content was <0.1%. This gave an acetonic solution of a hydroxy-functional polyurethane. Following the addition of 24.9 g of dimethylethanolamine as neutralizing agent, the product was dispersed by addition of 600 g of demineralized water, and the acetone was removed by distillation.

This gave a clear, aqueous, hydroxy-functional polyurethane solution having a urea group content of 12.6% by weight, a hydroxyl group content of 3.8% by weight (based in each case on solids content), a solids content of 65% by weight and a viscosity of 12000 mPas. The aqueous polyurethane solution was virtually solvent-free, with a pH of 7.1.

### Polyurethane Solution 2)

A mixture of 8.7 g of butanediol, 195 g of Desmophen® C2200, 80 g of Desmophen® 3600 and 42.4 g of dimethylolpropionic acid was diluted with 353 g of acetone and admixed at 40° C. with a mixture of 183.2 g of isophorone diisocyanate and 315.2 g of Desmodur® N 100. It was stirred at 60° C. until the theoretical NCO content reached, or fell slightly below, 7.8%. This isocyanate-functional intermediate solution was diluted with 320 g of acetone and then incorporated with stirring into an initial charge mixture, introduced at room temperature, of 165 g of N-methylethanolamine and 149 g of acetone, the resulting mixture being stirred at 50° C. until the NCO content was =0. This gave an acetonic dispersion of a hydroxy-functional polyurethane. Following the addition of 25.3 g of dimethylethanolamine as neutralizing agent, the product was dispersed by addition of 900 g of demineralized water, and the acetone was then removed by distillation.

This gave a clear, aqueous, hydroxy-functional polyurethane solution having a urea group content of 12.7% by weight, a hydroxyl group content of 3.8% by weight (based in each case on solids content), a solids content of 51% by weight and a viscosity of 3800 mPas. The aqueous polyurethane solution was virtually solvent-free, with a pH of 7.8.

### Polyurethane Solution 3)

A mixture of 7 g of neopentyl glycol, 250 g of Desmophen® 2028, 11.3 of MPEG750 and 40.2 of dimethylolpropionic acid was diluted with 356 g of acetone and admixed at 40° C. with a mixture of 166.5 g of isophorone diisocyanate and 292.5 g of Desmodur® N 3300. It was stirred at 60° C. until the theoretical NCO content was slightly below 7.7%. This isocyanate-functional prepolymer solution was diluted with 283 g of acetone and then incorporated with stirring into an initial charge mixture, introduced at room temperature, of 210 g of diethanolamine and 137 g of acetone, the resulting mixture being stirred at 50° C. until the NCO content was =0. This gave a bluish acetonic dispersion of a hydroxy-functional polyurethane. Following the addition of 19.4 g of 25% strength aqueous ammonia solution, the product was dispersed by addition of 620 g of demineralized water, and the acetone was then removed by distillation.

This gave a clear and colourless, aqueous, hydroxy-functional polyurethane solution having a urea group content of 12.2% by weight and a hydroxyl group content of 7.0% by weight (based in each case on solids content). On storage, the aqueous solution may become cloudy as a result of crystallization; this was reversible and can be eliminated again by brief, gentle heating. The polyurethane solution has a solids content of 61% by weight, a viscosity of 7000 mPas, was solvent-free and has a pH of 7.5.

### Polyurethane Solution 4)

A mixture of 19.5 g of trimethylolpropane, 253.7 g of polyester P200H and 40.7 g of dimethylolpropionic acid was diluted with 341 g of acetone and admixed at 40° C. with a mixture of 248.9 g of isophorone diisocyanate and 253.1 g of Desmodur® N 3300. It was stirred at 60° C. until the theoretical NCO content reached 81.1%. This isocyanate-functional prepolymer solution was diluted with 290 g of acetone and then incorporated with stirring into an initial charge mixture, introduced at room temperature, of 168.2 g of N-methylethanolamine and 144 g of acetone, the resulting mixture being stirred at about 50° C. until the NCO content was =0. Following the addition of 24.3 g of dimethylethanolamine as neutralizing agent, the product was dispersed by addition of 850 g of demineralized water, and the acetone was then removed by distillation.

This gave a clear, aqueous, hydroxy-functional polyurethane solution having a urea group content of 12.7% by weight, a hydroxyl group content of 3.9% by weight (based in each case on solids content), a solids content of 54% by weight and a viscosity of 8900 mPas. The aqueous polyurethane solution was clear, colourless and virtually solvent-free, with a pH of 8.6.

### Polyurethane Solution 5)

A mixture of 13.3 g of neopentyl glycol, 289 g of polyester P200A and 31.9 g of dimethylolpropionic acid was diluted with 327 g of acetone and admixed at 40° C. with a mixture of 221 g of isophorone diisocyanate and 209 g of Desmodur® N 3300. It was stirred at 55° C. until the NCO content reached 7.4% (theoretical: 7.8%). This isocyanate-functional prepolymer solution was diluted with 329 g of acetone and then incorporated with stirring into an initial charge mixture, introduced at room temperature, of 144.5 g of N-methylethanolamine and 139 g of acetone, the resulting mixture being stirred at 50° C. until the NCO content was =0. Following the addition of 19.2 g of triethylamine as neutralizing agent, the product was dispersed by addition of 790 g of demineralized water, and the acetone was then removed by distillation.

This gave a clear, aqueous, hydroxy-functional polyurethane solution having a urea group content of 12.4% by weight, a hydroxyl group content of 3.8% by weight (based in each case on solids content), a solids content of 54% by weight and a viscosity of 6600 mPas. The aqueous polyurethane solution was clear, colourless and virtually solvent-free, with a pH of 8.

### Polyurethane Solution 6)

A mixture of 5 g of butanediol, 127.5 g of Desmophen® 2028, 127.5 g of polyester P200H and 43.7 g of dimethylolpropionic acid was diluted with 330 g of acetone and admixed at 40° C. with a mixture of 169.8 g of isophorone diisocyanate, 240 g of Desmodur® N 3300 and 57 g of Desmodur® N100. It was stirred at 60° C. until the theoretical NCO content was 7.8% or slightly below. This isocyanate-functional prepolymer solution was diluted with 300 g of acetone and then incorporated with stirring into an initial charge mixture, introduced at room temperature, of 214 g of diethanolamine and 140 g of acetone, the resulting mixture being stirred at 50° C. until the NCO content was =0. This gave a turbid acetonic dispersion of a hydroxy-functional polyurethane. Following the addition of 21.1 g of 25% strength aqueous ammonia solution as neutralizing agent, the product was dispersed by addition of 525 g of demineralized water, and the acetone was then removed by distillation.

This gave a clear, aqueous, hydroxy-functional polyurethane solution having a urea group content of 11.4% by weight, a hydroxyl group content of 7.0% by weight (based in each case on solids content), a solids content of 63% by weight and a viscosity of 2400 mPas. The clear aqueous polyurethane solution was virtually solvent-free, with a pH of 7.4.

### Polyurethane Solution 7)

A mixture of 7.5 g of neopentyl glycol, 264 g of Desmophen® 2028 and 37 g of dimethylolpropionic acid was diluted with 321 g of acetone and admixed at 40° C. with a mixture of 159.8 g of isophorone diisocyanate and 281 g of Desmodur® N 3300. It was stirred at 60° C. until the theoretical NCO content reached 7.8%. This isocyanate-functional prepolymer solution was diluted with 292 g of acetone and then incorporated with stirring into an initial charge mixture, introduced at room temperature, of 50.4 g of diethanolamine, 108 g of N-methylethanolamine and 136 g of acetone, the resulting mixture being stirred at 50° C. until the NCO content was =0. This gave a bluish acetonic dispersion of a hydroxy-functional polyurethane. Following the addition of 17.2 g of dimethylethanolamine as neutralizing agent, the product was dispersed by addition of 530 g of demineralized water, and the acetone was then removed by distillation.

This gave a clear, aqueous, hydroxy-functional polyurethane solution having a urea group content of 12% by weight, a hydroxyl group content of 4.5% by weight (based in each case on solids content), a solids content of 64% by weight and a viscosity of 7500 mPas. The clear aqueous polyurethane solution was virtually solvent-free, with a pH of 6.5. On prolonged storage, the clear solution may become cloudy as a result of crystallization. This crystallization was reversible; brief heating at about 45° C. returned a clear solution.

### Polyurethane Solution 8)

A mixture of 24.2 g of neopentyl glycol, 275 g of polyester P200H and 100 ppm of dibutyl phosphate was diluted with 345 g of acetone and admixed at 40° C. with a mixture of 183.2 g of isophorone diisocyanate and 321.8 g of Desmodur® N 3300. It was stirred at 65° C. until the theoretical NCO content reached 9.4%. This isocyanate-functional prepolymer solution was diluted with 313 g of acetone and then incorporated with stirring into an initial charge mixture, introduced at room temperature, of 41.2 g of N-methylethanolamine, 146.3 g of diisopropanolamine, 41.2 g of a 45% strength aqueous solution of the sodium salt of 2-(2-aminoethyl)aminoethanesulfonic acid and 146 g of acetone, the resulting mixture being stirred at 60° C. until the NCO content was =0. This gave an acetonic, slightly turbid dispersion of a hydroxy-functional polyurethane. Dispersion was carried out by adding 950 g of demineralized water, and the acetone was removed by distillation.

This gave a slightly opaque, aqueous, hydroxy-functional polyurethane solution having a urea group content of 12.7% by weight, a hydroxyl group content of 5.5% by weight (in each case based on solids content), a solids content of 53% by weight and a viscosity of 5000 mPas with a pH of 9.9.

### Polyurethane Solution 9)

A mixture of 8.1 g of neopentyl glycol, 245 g of a dihydroxy-functional polyester with a molecular weight of 1380 g/mol, prepared from isophthalic acid, neopentyl glycol and ethylene glycol, and 35.5 g of dimethylolpropionic acid was diluted with 328 g of acetone and admixed at 40° C. with a mixture of 173.2 g of isophorone diisocyanate and 304.2 g of Desmodur® N 3300. It was stirred at 60° C. until the theoretical NCO content was 8% or slightly below. This isocyanate-functional prepolymer solution was diluted with 298 g of acetone and then incorporated with stirring into an initial charge mixture, introduced at room temperature, of 156 g of N-methylethanolamine and 139 g of acetone, the resulting mixture being stirred at 55° C. until the NCO content was =0. Following the addition of 20.5 g of dimethylethanolamine as neutralizing agent, the product was dispersed by addition of 770 g of demineralized water, and the acetone was then removed by distillation.

This gave an opaque, aqueous, hydroxy-functional polyurethane solution having a urea group content of 12.6% by weight, a hydroxyl group content of 3.8% by weight (based in each case on solids content), a solids content of 55% by weight and a viscosity of 10000 mPas. The aqueous polyurethane solution was virtually solvent-free, with a pH of 8.4.

### Polyurethane Solution 10)

A mixture of 23.9 g of butanediol, 270.3 g of polyester P200H and 19.5 g of dimethylolpropionic acid was diluted with 333 g of acetone and admixed at 40° C. with a mixture of 175.5 g of isophorone diisocyanate and 288.4 g of Desmodur® N 3300. It was stirred at 60° C. until the NCO content was slightly below the theoretical NCO content. This isocyanate-functional intermediate solution was diluted with 300 g of acetone and then incorporated with stirring into an initial charge mixture, introduced at room temperature, of 214 g of diethanolamine and 141 g of acetone over 30 minutes, the resulting mixture being stirred at 50° C. until the NCO content was <0.1%. This gave an acetonic dispersion of a hydroxy-functional polyurethane. Following the addition of 12.9 g of triethylamine as neutralizing agent, the product was dispersed by addition of 5200 g of demineralized water, and the acetone was removed by distillation.

This gave a clear, aqueous, hydroxy-functional polyurethane solution having a urea group content of 11.7% by weight, a hydroxyl group content of 7.0% by weight (based in each case on solids content), a solids content of 66% by weight and a viscosity of 10000 mPas. The aqueous polyurethane solution was virtually solvent-free, with a pH of 6.6.

### Polyurethane Solution 11)

A mixture of 8.5 g of butanediol, 270 g of Desmophen® 3600 and 41.6 g of dimethylolpropionic acid was diluted with 349 g of acetone and admixed at 40° C. with a mixture of 179.8 g of isophorone diisocyanate and 315.9 g of Desmodur® N 3300. It was stirred at 60° C. until the theoretical NCO content reached 7.8%. This isocyanate-functional intermediate solution was diluted with 200 g of acetone and then incorporated with stirring into an initial charge mixture, introduced at room temperature, of 162 g of N-methylethanolamine and 148 g of acetone over 30 minutes, the resulting mixture being stirred at 50° C. until the NCO content was =0%. This gave an acetonic, bluish dispersion of a hydroxy-functional polyurethane. Following the addition of 28.2 g of triethylamine as neutralizing agent, the product was dispersed by addition of 700 g of demineralized water, and the acetone was removed by distillation.

This gave a clear, aqueous, hydroxy-functional polyurethane solution having a urea group content of 12.2% by weight a hydroxyl group content of 3.8% by weight (based in each case on solids content), a solids content of 55% by weight and a viscosity of 2000 mPas. The aqueous polyurethane solution was virtually solvent-free, with a pH of 7.1.

### Polyurethane Solution 12)

Comparison: Use of a Triol (Trimethylolpropane) Instead of an Amino Alcohol with Secondary Amino Group as Component d)

A mixture of 7.4 g of butanediol, 275 g of Desmophen® 2028 and 40.3 g of dimethylolpropionic acid was diluted with 339 g of acetone and admixed at 40° C. with a mixture of 169.8 g of isophorone diisocyanate and 298.4 g of Desmodur® N 3300. It was stirred at 60° C. until the theoretical NCO content reached 7.6%. This isocyanate-functional prepolymer solution was diluted with 144 g of acetone and then incorporated with stirring into an initial charge mixture, introduced at room temperature, of 273 g of trimethylolpropane and 308 g of acetone, the resulting mixture being stirred at 50° C. until the NCO content was =0. About 3 hours after the start of this reaction, the batch gels.

By using a triol as component d) instead of an amino alcohol with secondary amino group it was not possible by this route to prepare aqueous hydroxy-functional polyurethane solutions.

### Polyurethane Solution 13)

Comparison: Use of an Amino Alcohol with Primary Amino Group Instead of an Amino Alcohol with Secondary Amino Group as Component d)

A mixture of 8.7 g of butanediol, 275 g of Desmophen® C2200 and 42.4 of dimethylolpropionic acid was diluted with 356 g of acetone and admixed at 40° C. with a mixture of 183.2 g of isophorone diisocyanate and 321.8 g of Desmodur® N 3300. It was stirred at 60° C. until the theoretical NCO content reached 7.8% or slightly below. This isocyanate-functional prepolymer solution was diluted with 323 g of acetone and then incorporated with stirring into an initial charge mixture, introduced at room temperature, of 136.6 g of ethanolamine and 154 g of acetone, the resulting mixture being stirred at 50° C. until the NCO content was =0. This gave an acetonic dispersion of a hydroxy-functional polyurethane. Following addition of 25.3 g of dimethylethanolamine as neutralizing agent, the batch was dispersed by addition of 575 g of demineralized water, and the acetone was then removed by distillation.

This gave a clear, aqueous, hydroxy-functional polyurethane solution having an extremely high viscosity, which must be diluted by addition of a further 1050 g of water in order to be fluid at room temperature. The brown-coloured, aqueous polyurethane solution thus prepared has a solids content of only 35% by weight, a viscosity of 8500 mPas and a hydroxyl group content of 3.8% by weight (based in each case on solids content).

This comparative experiment shows the disadvantages of the use of an amino alcohol d) with primary amino groups instead of the use of amino alcohols with secondary amino groups. Aqueous solutions are obtained which have a very low solids content and severe discoloration. It was therefore not advisable to use amino alcohols with a primary amino group exclusively; their accompanying use in minor amounts was possible, but not preferred.

### Polyurethane Solution 14)

Comparison: Use of a Triamine Instead of an Amino Alcohol with Secondary Amino Group as Component d)

A mixture of 8.8 g of butanediol, 260 g of Desmophen® C2200 and 39.2 g of dimethylolpropionic acid was diluted with 336 g of acetone and admixed at 40° C. with a mixture of 173.2 g of isophorone diisocyanate and 304.2 g of Desmodur® N 3300. It was stirred at 60° C. until the theoretical NCO content reached 7.8%. This isocyanate-functional prepolymer solution was diluted with 306 g of acetone and then incorporated with stirring into an initial charge mixture, introduced at room temperature, of 209 g of diethylenetriamine and 143 g of acetone, at which point there is, immediately, copious precipitation and strong crosslinking reactions.

This comparative experiment shows that it was not possible to prepare corresponding aqueous polyurethane solutions by using a triamine instead of an amino alcohol component d) with a secondary amino group.

### Polyurethane Solution 15)

Comparison: Use of a Diol (Propylene Glycol) Instead of an Amino Alcohol with Secondary Amino Group as Component d)

A mixture of 3.9 g of butanediol and 346.8 of Desmophen® 2028 and 39.3 g of dimethylolpropionic acid was diluted with 368 g of acetone and admixed at 40° C. with a mixture of 169.8 g of isophorone diisocyanate and 298.4 g of Desmodur® N 3300. This mixture was stirred at 60° C. until the theoretical NCO content of 7.0% was reached. This isocyanate-functional prepolymer solution was diluted with 334 g of acetone and then introduced with stirring into an initial charge mixture, introduced at room temperature, of 155 g of 1,2-propylene glycol and 156 g of acetone, the resulting mixture was stirred at 50° C. until the NCO content=0. This gave an acetonic solution of a hydroxy-functional polyurethane. Following addition of 23.5 g of triethylamine as neutralizing agent, dispersion was carried out by addition of a total of 2200 g of demineralized water, and the acetone was then removed by distillation.

This gave a turbid, aqueous, hydroxy-functional polyurethane dispersion, with a very large number of gel particles, having a hydroxyl group content of 3.4% by weight (based on solids content), a solids content of only 32% by weight and a viscosity of 5000 mPas.

This comparative experiment shows that it was not possible to prepare corresponding, clear, homogeneous aqueous polyurethane solutions containing no gel particles and having high solids contents by using a diol with a primary and a secondary hydroxyl group instead of an amino alcohol component d) with a secondary amine group.

### Polyurethane Solution 16)

A mixture of 8.4 g of neopentyl glycol, 300 g of Desmophen® 2028, 13.5 g of MPEG 750 and 48.2 g of dimethylolpropionic acid was diluted with 389 g of acetone and admixed at 40° C. with a mixture of 199.8 g of isophorone diisocyanate and 305.4 g of Desmodur® N 3300. It was stirred at 60° C. until the theoretical NCO content reached 7.7%. This isocyanate-functional prepolymer solution was diluted with 340 g of acetone and then incorporated with stirring into an initial charge mixture, introduced at room temperature, of 252 g of diethanolamine and 165 g of acetone, the resulting mixture being stirred at 50° C. until the NCO content was =0. This gave an acetonic, turbid-white dispersion of a hydroxy-functional polyurethane. Following the addition of 30.4 g of dimethylethanolamine as neutralizing agent, the product was dispersed by addition of 650 g of demineralized water, and the acetone was then removed by distillation.

This gave a clear, aqueous, hydroxy-functional polyurethane solution having a urea group content of 11.4% by weight and a hydroxyl group content of 7.0% by weight (based in each case on solids content). On storage, the aqueous polyurethane solution may become cloudy as a result of incipient crystallization; this can be eliminated again by brief, gentle heating. The polyurethane solution has a solids content of 63% by weight, a viscosity of 3000 mPas, was clear, colourless and virtually solvent-free, with a pH of 7.4.

### Polyurethane Solution 17)

A mixture of 12.9 g of neopentyl glycol, 110 g of Desmophen® 2028 165 g of polyester P200H and 38.7 g of dimethylolpropionic acid was diluted with 288 g of acetone and admixed at 40° C. with a mixture of 174 g of isophorone diisocyanate 219.9 g of Desmodur® N 100 and 116.8 g of Desmodur® N 3400. It was stirred at 60° C. until the theoretical NCO content reached 8.2%. This isocyanate-functional prepolymer solution was diluted with 97 g of acetone and then incorporated with stirring into an initial charge mixture, introduced at room temperature, of 82.5 g of N-methylethanolamine, 115.5 g of diethanolamine and 122 g of acetone, the resulting mixture being stirred at 50° C. until the NCO content was =0. Following the addition of 26.2 g of triethylamine as neutralizing agent, the product was dispersed by addition of 750 g of demineralized water, and the acetone was then removed by distillation.

This gave a clear, aqueous, hydroxy-functional polyurethane solution having a urea group content of 11.8% by weight, a hydroxyl group content of 5.4% by weight (based in each case on solids content), a solids content of 57% by weight and a viscosity of 13000 mPas. The aqueous polyurethane solution was clear, colourless and virtually solvent-free, with a pH of 8.5.

### Polyurethane Solution 18)

A mixture of 6.7 g of neopentyl glycol, 118.8 g of Desmophen® 2028 118.8 g of polyester P200H and 38.2 g of dimethylolpropionic acid was diluted with 308 g of acetone and admixed at 40° C. with a mixture of 138.2 g of isophorone diisocyanate, 15.1 g of hexamethylene diisocyanate and 278 g of Desmodur® N 3300. It was stirred at 60° C. until the theoretical NCO content reached 7.7%. This isocyanate-functional prepolymer solution was diluted with 269 g of acetone and then incorporated with stirring into an initial charge mixture, introduced at room temperature, of 252.7 g of diisopropanolamine and 130 g of acetone, the resulting mixture being stirred at 50° C. until the NCO content was =0. This give a bluish acetonic dispersion of the hydroxy-functional polyurethane. Following the addition of 24.1 g of triethylamine as neutralizing agent, the product was dispersed by addition of 520 g of demineralized water, and the acetone was then removed by distillation.

This gave an optically clear, aqueous, hydroxy-functional polyurethane solution having a urea group content of 10.8% by weight and a hydroxyl group content of 6.6% by weight (based in each case on solids content). The polyurethane solution may turn cloudly on storage; however, this was reversible and can be eliminated again by gentle heating, for example. The polyurethane solution has a solids content of 64% by weight, a viscosity of 12000 mPas, and was colourless and virtually solvent-free, with a pH of 7.6.

### Polyurethane Solution 19)

A mixture of 16.4 g of butanediol, 225 g of polyester P200H and 27.5 g of dimethylolpropionic acid was diluted with 321 g of acetone and admixed at 40° C. with a mixture of 166.5 g of isophorone diisocyanate 98.8 g of Desmodur® Z 4400 and 214.5 g of Desmodur® N 3300. It was stirred at 60° C. until the theoretical NCO content reached 7.85%. This isocyanate-functional prepolymer solution was diluted with 291 g of acetone and then incorporated with stirring into an initial charge mixture, introduced at room temperature, of 11.1 g of diethanolamine, 142.5 g of N-methylethanolamine, and 136 g of acetone, the resulting mixture being stirred at 50° C. until the NCO content was =0. This gave an almost clear, acetonic dispersion of the hydroxy-functional polyurethane. Following the addition of 16.6 g of dimethylethanolamine as neutralizing agent, the product was dispersed by addition of 750 g of demineralized water, and the acetone was then removed by distillation.

This gave an optically clear, aqueous, hydroxy-functional polyurethane solution having a urea group content of 11.7% by weight, a hydroxyl group content of 4.0% by weight (based in each case on solids content), a solids content of 55% by weight and a viscosity of 12000 mPas. The aqueous polyurethane solution was colourless and virtually solvent-free, with a pH of 7.5.

### Polyurethane Solution 20)

A mixture of 66.3 g of neopentyl glycol and 28.5 g of dimethylolpropionic acid was diluted with 315 g of acetone and admixed at 40° C. with a mixture of 142.8 g of hexamethylene diisocyanate and 497 g of Desmodur® N 3300. It was stirred at 60° C. until the theoretical NCO content reached 10.2%. This isocyanate-functional prepolymer solution was diluted with 286 g of acetone and then incorporated with stirring into an initial charge mixture, introduced at room temperature, of 268 g of diethanolamine, and 134 g of acetone, the resulting mixture being stirred at 50° C. until the NCO content was =0. This gave a relatively coarse, acetonic dispersion of the hydroxy-functional polyurethane. Following the addition of 3.3 g of ammonia as neutralizing agent, the product was dispersed by addition of 520 g of demineralized water, and the acetone was then removed by distillation.

This gave an optically clear, aqueous, hydroxy-functional polyurethane solution having a urea group content of 14.5% by weight, a hydroxyl group content of 8.6% by weight (based in each case on solids content), a solids content of 67% by weight and a viscosity of 13000 mPas. The aqueous polyurethane solution was colourless and virtually solvent-free, with a pH of 7.1.

### Polyurethane Solution 21)

A mixture of 270 g of polyester P200H and 47.8 g of N-methyldiethanolamine was diluted with 412 g of acetone and admixed at 40° C. with a mixture of 179.8 g of isophorone diisocyanate and 315.9 g of Desmodur® N 3300. It was stirred at 55 to 60° C. until the theoretical NCO content reached 7.4%. This isocyanate-functional prepolymer solution was diluted with 139 g of acetone and then incorporated with stirring into an initial charge mixture, introduced at room temperature, of 121.5 g of N-methylethanolamine, 56.7 g of diethanolamine and 151 g of acetone, the resulting mixture being stirred at 55° C. until the NCO content was =0. Following the addition of 40 g of 85% strength aqueous phosphoric acid as neutralizing agent, the product was dispersed by addition of 1100 g of demineralized water, and the acetone was then removed by distillation.

This gave a slightly opaque, aqueous, hydroxy-functional polyurethane solution having a urea group content of 13.3% by weight, a hydroxyl group content of 4.6% by weight (based in each case on solids content), a solids content of 47% by weight and a viscosity of 1000 mPas. The aqueous polyurethane solution was colourless and virtually solvent-free. The pH of the aqueous solution was 5.8.

### Polyurethane Solution 22)

A mixture of 132.5 g of polyether LP112, 132.5 g of Terathane® 2000 and 44.4 g of dimethylolpropionic acid was diluted with 351 g of acetone and admixed at 40° C. with a mixture of 198.8 of Desmodur® M44 and 310 g of Desmodur® N 3300. It was stirred at 60° C. until the theoretical NCO content reached 7.56%. This isocyanate-functional prepolymer solution was diluted with 321 g of acetone and then incorporated with stirring into an initial charge mixture, introduced at room temperature, of 11.1 g of diisopropanolamine, 146.5 g of N-methylethanolamine, and 150 g of acetone, the resulting mixture being stirred at 50° C. until the NCO content was =0. This gave an almost bluish, acetonic dispersion of the hydroxy-functional polyurethane. Following the addition of 33.5 g of dimethylethanolamine as neutralizing agent, the product was dispersed by addition of 890 g of demineralized water, and the acetone was then removed by distillation.

This gave an optically clear, aqueous, hydroxy-functional polyurethane solution having a urea group content of 12% by weight, a hydroxyl group content of 3.7% by weight (based in each case on solids content), a solids content of 50% by weight and a viscosity of 10000 mPas. The aqueous polyurethane solution was colourless and virtually solvent-free, with a pH of 8.0.

### Polyurethane Solution 23)

A mixture of 270 g of polyester P200A, 8.5 g of butanediol and 41.6 g of dimethylolpropionic acid was diluted with 350 g of acetone and admixed at 40° C. with a mixture of 179.8 of isophorone diisocyanate and 316 g of Desmodur® N 3300. It was stirred at 60° C. until the theoretical NCO content reached 7.8%. This isocyanate-functional prepolymer solution was diluted with 318 g of acetone and then incorporated with stirring into an initial charge mixture, introduced at room temperature, of 162 g of N-methylethanolamine, and 150 g of acetone, the resulting mixture being stirred at 50° C. until the NCO content was =0. This gave a turbid, acetonic dispersion of the hydroxy-functional polyurethane. Following the addition of 24.9 g of dimethylethanolamine as neutralizing agent, the product was dispersed by addition of 750 g of demineralized water, and the acetone was then removed by distillation.

This gave an optically clear, aqueous, hydroxy-functional polyurethane solution having a urea group content of 12.3% by weight, a hydroxyl group content of 3.8% by weight (based in each case on solids content), a solids content of 57% by weight and a viscosity of 7000 mPas. The aqueous polyurethane solution was colourless and virtually solvent-free, with a pH of 8.9.

### Polyurethane Solution 24)

A mixture of 500 g of polyester P200A and 33.5 g of dimethylolpropionic acid was diluted with 375 g of acetone and admixed at 40° C. with a mixture of 180.4 of isophorone diisocyanate and 161 g of Desmodur® N 3300. It was stirred at 60° C. until the theoretical NCO content reached 4.9%. This isocyanate-functional prepolymer solution was diluted with 340 g of acetone and then incorporated with stirring into an initial charge mixture, introduced at room temperature, of 109 g of N-methylethanolamine, and 159 g of acetone, the resulting mixture being stirred at 50° C. until the NCO content was =0. This gave an acetonic dispersion of the hydroxy-functional polyurethane. Following the addition of 19.3 g of triethylamine as neutralizing agent, the product was dispersed by addition of 900 g of demineralized water, and the acetone was then removed by distillation.

This gave an optically clear, aqueous, hydroxy-functional polyurethane solution having a urea group content of 8.2% by weight, a hydroxyl group content of 2.5% by weight (based in each case on solids content), a solids content of 50% by weight and a viscosity of 1500 mPas. The aqueous polyurethane solution was colourless and virtually solvent-free, with a pH of 6.6.

### Performance Tests:

Crosslinker I): Desmodur® XP 2410 (polyisocyanate crosslinker based on hexamethylene diisocyanate with iminooxadiazinedione structural units; Bayer MaterialScience, Leverkusen, Germany; 100% form; isocyanate content about 24.0%)

Crosslinker II): Bayhydur® 304 (nonionically hydrophilicized polyisocyanate crosslinker based on hexamethylene diisocyanate; Bayer MaterialScience, Leverkusen, Germany; 100% form; isocyanate content about 18.2%)

Crosslinker III): Desmodur® N 3390 (polyisocyanate crosslinker based on hexamethylene diisocyanate with isocyanurate structural units; Bayer MaterialScience, Leverkusen, Germany; 90% in butyl acetate; isocyanate content about 19.6%)

Crosslinker IV): Desmodur® N 3400 (polyisocyanate crosslinker based on hexamethylene diisocyanate with uretdione structural units; Bayer MaterialScience, Leverkusen, Germany; 100% form; isocyanate content about 21.8%)

Crosslinker V): Bayhydur® XP 2655 (ionically hydrophilicized polyisocyanate crosslinker based on hexamethylene diisocyanate; Bayer MaterialScience, Leverkusen, Germany; 100% form)

Crosslinker VI): Desmodur® N 3300 (polyisocyanate crosslinker based on hexamethylene diisocyanate with isocyanurate structural units; Bayer MaterialScience, Leverkusen, Germany; 100% form; isocyanate content about 12.6%)

### 1) Testing of Freeze Stability

a) The two aqueous polyurethane solutions 1) and 2) are subjected to a deep-freezing cycle. This involves freezing samples in glass bottles at −78° C. in dry ice for an hour and then thawing them at room temperature for 3 hours. This cycle was repeated five times. Both solutions withstand this procedure completely intact; no changes were observed or measured.

b) The aqueous polyurethane solutions 1), 2), 4), 10), 20) and 21) are stored in a refrigerator at 0 to 4° C. for 3 weeks and then warmed to room temperature. All of the solutions withstand this storage completely intact; no changes were observed or measured.

c) The aqueous polyurethane solutions 1), 2) and 11) are frozen in glass bottles in a freezing compartment at −10 to −12° C. for two weeks and then thawed again. All of the solutions withstand this procedure completely intact; no changes were observed or measured.

Viewed overall, the aqueous polyurethane solutions of the invention exhibit excellent freeze stability and in this respect differ from virtually all aqueous dispersions, which do not withstand freezing without product damage.

2) Testing as a Clear Varnish in Combination with a Low-Viscosity Hydrophobic Polyisocyanate Crosslinker or with a Hydrophilicized Polyisocyanate Crosslinker Based on Hexamethylene Diisocyanate

The polyurethane solutions were mixed in the quantities stated with the respective crosslinker, the solvent and, where appropriate, the catalyst, and the mixtures were then homogenized at 2000 rpm for 2 minutes and subsequently adjusted by addition of distilled water to a flow time from the DIN 4 cup of 25 seconds.

| (Amounts in g) | 2a | 2b | 2c |
|---|---|---|---|
| Polyurethane solution 7) | 38.5 | | |
| Polyurethane solution 8) | | 63 | |
| Polyurethane solution 1) | | | 72.2 |
| Lithium molybdate, | 0.2 | — | — |
| 5% strength solution | | | |
| Crosslinker I) | | 26.9 | 26.9 |
| Crosslinker II) | 34.5 | — | — |
| Diluted with 3-methoxy- | 8.6 | 6.7 | 6.7 |
| n-butyl acetate | | | |
| Pendulum seconds after 30′ 60° C. | — | 26 s | 62 s |
| and 2 h RT drying | | | |
| Pendulum seconds after 1 d RT drying | — | 93 s | 96 s |
| Pendulum seconds after 2 d RT drying | — | 132 s | 161 s |
| Pendulum seconds after 5 d RT drying | — | 162 s | 158 s |
| Pendulum seconds after 7 d RT drying | — | 159 s | 155 s |
| Film transparency | clear | clear | clear |
| (under all drying conditions) | | | |
| Visual impression of the clear | excel- | excel- | excel- |
| varnish coats - fullness | lent | lent | lent |
| Visual impression of the clear | very | very | very |
| varnish coats - evenness | good | good | good |
| Visual impression of the clear | none | none | none |
| varnish coats - surface defects | | | |

Although the clear varnish formulations in questions are very simple formulations, without any additive, the coatings obtained have excellent visual film properties, particularly in respect of fullness, evenness and surface defects. The incorporation of the curing agents caused no problems; completely transparent films were obtained, without haze or clouding, and with very high hardness as measured in pendulum seconds, of around 160 s.

3) Testing as a Clear Varnish in Combination with Different Hydrophobic Polyisocyanate Crosslinkers

The polyurethane solution 1) was mixed in the stated amounts with the respective crosslinker and the mixtures were homogenized at 2000 rpm for 2 minutes and then adjusted by addition of distilled water to a flow time from the DIN 4 cup of 25 seconds.

| (Amounts in g) | 3a) | 3b) |
|---|---|---|
| Polyurethane solution 1) | 72.2 | 72.2 |
| Crosslinker III) | 32.1 | |
| Crosslinker IV) | | 28.9 |
| NCO//OH ratio | 1.5 | 1.5 |
| Pendulum seconds after 1 day RT drying | 42 s | 48 s |
| Pendulum seconds after 30′ 60° C. and 4 h | 110 s | 42 s |
| RT drying | | |
| Pendulum seconds after 30′ 60° C. and 1 day | 136 s | 82 s |
| RT drying | | |
| Film transparency | clear | clear |
| Visual impression of the clear varnish coats - | excellent | excellent |
| fullness | | |
| Visual impression of the clear varnish coats - | very good | very good |
| evenness | | |
| Visual impression of the clear varnish coats - | none | none |
| surface defects | | |

Despite the fact that the clear varnish formulations in question are extremely simple, without any additive and without additional organic solvents, the coatings obtained have excellent visual film properties, particularly in respect of fullness, evenness and surface defects.

No problems were experienced incorporating the curing agents; the films obtained were completely transparent, without haze or clouding, and had good hardness values. Particularly noteworthy was the very high compatibility with the crosslinker III), an HDI trimer of relatively high viscosity whose use in combination with typical aqueous dispersions leads, as a general rule, to films with a greater or lesser degree of clouding, with inadequate gloss values. Even the butyl acetate present in this curing agent does not exhibit any adverse effect. When commercially customary dispersions are used in combination with crosslinkers containing butyl acetate, it is very common to observe a thickening effect, which can go as far as the formation of gel particles. Consequently, crosslinkers of this kind, which are used very frequently in solvent-borne 2 K [2-component] PU systems, have been used to date in aqueous 2 K PU systems only in exceptional cases, and even then, in general, only in combination with other crosslinkers.

4) Testing as a Pigmented Top Coat in Combination with a Hydrophilic Crosslinker:

| (Amounts in g) | 4a | 4b | 4c | 4d |
|---|---|---|---|---|
| Polyurethane solution 7) | 66.3 | | | |
| Polyurethane solution 4) | | 80.7 | | |
| Polyurethane solution 9) | | | 82.8 | |
| Polyurethane solution 19) | | | | 80.7 |
| Surfinol BC 104 (50% form), (wetting assistant, air | 2.2 | 2.3 | 2.3 | 2.3 |
| products) | | | | |
| Borchigel PW25 (25% form) (thickener; Borchers | 0.3 | 0.3 | 0.3 | 0.3 |
| GmbH) | | | | |
| Baysilone 3468 (10% in methoxypropyl acetate) | 1.8 | 2 | 2 | 2 |
| (Borchers GmbH) | | | | |
| Titanium dioxide Tronox RK-B-4 (Kerr-McGee | 43.4 | 46.9 | 47.6 | 46.9 |
| pigments) | | | | |
| Borchigen SN 95 (dispersing additives; Borchers | 5.2 | 5.6 | 5.7 | 5.6 |
| GmbH) | | | | |
| 45 min mixing in a Scandex disperser | | | | |
| Addition of crosslinker II (100% form) | 34.6 | 34.6 | 34.6 | 34.6 |
| Diluted with butoxyl(3-methoxy-butanol acetate) | 8.7 | 8.7 | 8.7 | 8.7 |
| Mixed for 2 minutes at 2000 rpm in an Ultraturrax | | | | |
| Addition of distilled water for flow time of 24 s from | 55 | 49 | 45 | 55 |
| DIN 4 cup as per DIN 53211 | | | | |
| pH | 7 | 7 | 6.9 | 7 |
| Solids of top coat, ready-to-spray | 52% | 51% | 52% | 50% |
| Pendulum hardness (s) as per DIN 53157 after 1 d RT | 42 s | 71 s | 66 s | 52 s |
| drying | | | | |
| Pendulum hardness (s) after 2 d RT drying | 82 s | 100 s | 116 s | 88 s |
| Pendulum hardness (s) after 3 d RT drying | 95 s | 121 s | 118 s | 93 s |
| Ultimate hardness (s) after drying 30 min 60° C. + 7 | 111 s | 141 s | 156 s | 139 s |
| days RT | | | | |
| Elasticity (Erichsen cupping in mm) as per DIN | 10 mm | 10 mm | 9 mm | 9 mm |
| 53157 | | | | |
| 5 min chemical test after 7 days of drying at room | 1/0/0/1 | 1/0/0/3 | 1/0/1/2 | 1/1/0/2 |
| temperature (super-grade petrol/methoxypropyl | | | | |
| acetate/xylene/ethanol)* | | | | |
| Water resistance after 30 min 60° C. and 7 days of | 1 | 2 | 2 | 2 |
| drying at room temperature** | | | | |
| Gloss (20° angle, Gardner) after room-temperature | 79 | 86 | 83 | 73 |
| drying | | | | |
| Gloss (20° angle) after 30 min 60° C. drying | 79 | 82 | 81 | 73 |
| Visual impression of the clear coat films - fullness | excel- | excel- | excel- | very |
| | lent | lent | lent | good |
| Visual impression of the clear coat films - surface | none | none | none | none |
| defects | | | | |

*Chemical resistance, assessment from 0 to 5; 0 = best value; 5 = worst value 0 = no finding/1 = slight, reversible softening/2 = reversible softening/3 = reversible clouding 4 = swollen/5 = detached

Pigmented top coat materials based on the aqueous polyurethane solutions of the invention and a hydrophilic crosslinker lead to coatings having very good mechanical properties, in hardness and elasticity, for example, very good resistance properties, and, all in all, excellent optical film properties, particularly in respect of fullness, film optical qualities, clouding/haze, and surface defects. The haze values are in general only 20%.

5) Testing as a Pigmented Top Coat in Combination with a Hydrophilic Crosslinker of Relatively High Viscosity:

| (Amounts in g) | 5a | 5b | 5c | 5d | 5e |
|---|---|---|---|---|---|
| Polyurethane solution 7) | 66.3 | | | | |
| Polyurethane solution 4) | | 80.7 | | | |
| Polyurethane solution 9) | | | 82.8 | | |
| Polyurethane solution 5) | | | | 82.8 | |
| Polyurethane solution 19) | | | | | 80.7 |
| Surfinol BC 104 (50% form | 2.2 | 2.3 | 2.3 | 2.2 | 2.3 |
| as supplied), (wetting | | | | | |
| assistant, air products) | | | | | |
| Borchigel PW25 (25% form | 0.3 | 0.3 | 0.3 | 0.3 | 0.3 |
| as supplied) (thickener; | | | | | |
| Borchers GmbH) | | | | | |
| Baysilone 3468 (10% | 1.7 | 1.8 | 1.8 | 1.8 | 1.8 |
| strength) | | | | | |
| Titanium dioxide Tronox RK- | 40 | 43.5 | 44.2 | 44.2 | 43.5 |
| B-4 (Kerr-McGee pigments) | | | | | |
| Borchigen SN 95 (dispersing | 4.8 | 5.2 | 5.3 | 5.3 | 5.2 |
| additive; Borchers GmbH) | | | | | |
| 45 min mixing in a Scandex | | | | | |
| disperser | | | | | |
| Addition of crosslinker VI | 28.9 | 28.9 | 28.9 | 28.9 | 28.9 |
| (100% form) | | | | | |
| Diluted with butoxyl(3- | 7.2 | 7.2 | 7.2 | 7.2 | 7.2 |
| methoxy-butanol acetate) | | | | | |
| Mixed for 2 minutes at | | | | | |
| 2000 rpm with an Ultraturrax | | | | | |
| Addition of distilled water for | 46 | 40 | 41 | 36 | 44 |
| flow time of 24 sec from DIN | | | | | |
| 4 cup | | | | | |
| pH | 7 | 7 | 7 | 6.7 | 7 |
| Solids of top coat, ready-to- | 53% | 53% | 53% | 53% | 52% |
| spray | | | | | |
| Flow time DIN 4 | 24 s | 24 s | 24 s | 24 s | 24 s |
| 0 h | | | | | |
| 1 h | 25 s | 22 s | 25 s | 60 s | 25 s |
| 2 h | 26 s | 22 s | 25 s | >60 s | 31 s |
| Pendulum seconds after 1 d | 18 s | 62 s | 88 s | 56 s | 62 s |
| RT drying | | | | | |
| Pendulum seconds after 2 d | 125 s | 102 s | 171 s | 104 s | 95 s |
| RT drying | | | | | |
| Pendulum seconds after 3 d | 132 s | 98 s | 160 s | 99 s | 85 s |
| RT drying | | | | | |
| Pendulum seconds after 7 d | 155 s | 116 s | 171 s | 114 s | 109 s |
| RT drying | | | | | |
| Ultimate hardness in | 150 s | 168 s | 191 s | 159 s | 172 s |
| pendulum seconds after | | | | | |
| drying 30 min 60° C. and 7 | | | | | |
| days RT | | | | | |
| 5 min chemical test after 30 | 1/0/0/1 | 0/0/0/2 | 0/1/0/2 | 1/0/0/3 | 0/0/0/2 |
| min 60° C. + 7 days of drying | | | | | |
| at room temperature (super- | | | | | |
| grade petrol/methoxypropyl | | | | | |
| acetate/xylene/ethanol)* | | | | | |
| Water resistance after 30 min | 1 | 1 | 1 | 1 | 1 |
| 60° C. and 7 days of drying at | | | | | |
| room temperature** | | | | | |
| Gloss (20° angle) after room- | 81 | 76 | 86 | 84 | 86 |
| temperature drying | | | | | |
| Gloss (20° angle) after 30 min | 81 | 81 | 86 | 88 | 83 |
| 60° C. drying | | | | | |
| Visual impression of the clear | excellent | excellent | excellent | excellent | excellent |
| coat films - fullness | | | | | |
| Visual impression of the clear | none | none | none | none | none |
| coat films - surface defects | | | | | |

*Chemical resistance, assessment from 0 to 5; 0 = best value; 5 = worst value
**Water resistance, assessment from 0 to 5; 0 = best value, 5 = wost value
0 = no finding/1 = slight, reversible softening/2 = reversible softening/3 = reversible clouding/4 = swollen/5 = detached

The testing of the aqueous polyurethane solutions of the invention in combination with a hydrophobic crosslinker VI) of relatively high viscosity leads to excellent results in terms of film hardness, resistance properties and, in particular, in the film optical properties such as fullness and gloss, for example. The absence of hydrophilic modification from the crosslinkers has a positive effect on the resistance properties.

Obtaining gloss values (20° angle) of well above 80% with a hydrophobic crosslinker was not possible with dispersions according to the prior art, especially not when only small amounts of organic solvents are used and where no special mixing techniques, or laborious mixing techniques, are used. Generally speaking, exclusive use of hydrophobic crosslinkers only provides coatings or finishes which are more or less cloudy and which do not meet the technical requirements.

6) Testing as a Clear Coat Under Baking Conditions in Combination with a Hydrophobic Crosslinker

The aqueous polyurethane solutions 18), 20) and 22) are mixed with the hydrophobic curing agent IV (90% strength in methoxypropyl acetate), using a 10% excess of isocyanate groups. Following dilution with distilled water, films are drawn down onto glass plates and, after evaporation at room temperature for 10 minutes, are cured at 140° C. for 30 min. After the films are cooled, the crosslinking was tested by means of a wipe test with MIBK (methyl isobutyl ketone).

An assessment is made of the appearance of/ damage to the films after 100 double rubs with a cotton pad soaked with MIBK

| | MIBK wipe test finding |
|---|---|
| Polyurethane solution 18) | Nothing found |
| Polyurethane solution 20) | Nothing found |
| Polyurethane solution 22) | Nothing found |

7) Test at Elevated Cured Temperature, as Clear Coat, with a Mixture of a Hydrophilic Crosslinker and a Hydrophobic Crosslinker

The aqueous polyurethane solutions 10), 11), 16) and 17) are mixed with a 1:1 mixture of the hydrophobic crosslinker VI) and the hydrophilic crosslinker V), using a 10% excess of isocyanate groups. Following dilution with distilled water, films are drawn down onto glass plates and, after evaporation at room temperature for 10 minutes, are cured at 110° C. for 30 min. After the films are cooled, the crosslinking was tested by means of a wipe test with MIBK (methyl isobutyl ketone).

An assessment was made of the appearance of damage to the films after 100 double rubs with a cotton pad soaked with MIBK.

| | MIBK wipe test finding |
|---|---|
| Polyurethane solution 10) | Nothing found |
| Polyurethane solution 11) | Reversible softening |
| Polyurethane solution 16) | Nothing found |
| Polyurethane solution 17) | Nothing found |

Crosslinking of the aqueous polyurethane solutions of the invention under baking conditions was likewise possible; by this route as well, very well-crosslinked coatings were obtained which have very good film optical properties.

1. A process for preparing an aqueous solution of a hydroxy-functional polyurethane containing urea groups and having a hydroxyl group content in the range of from 2% to 10% by weight and a level of urea groups, calculated as —NH—CO—NH—, derived from amino alcohols having a primary or secondary amino group and at least one hydroxyl group in the range of from 3% to 20% by weight, based in each case on the weight of said hydroxy-functional polyurethane containing urea groups, comprising
preparing an NCO-functional prepolymer by single-stage or multi-stage reaction of
a) at least one hydroxy- and/or amino-functional hydrophilicizing agent having at least one acid group and/or the salt of an acid group, or having at least one tertiary amino group and/or the salt of a tertiary amino group;
b) at least one polyol;
c) at least one polyisocyanate; and
d) optionally, other hydroxy- and/or amino-functional compounds, different from a), b), and e);
and reacting said NCO-functional prepolymer with
e) an amino alcohol component comprising an amino alcohol having a primary or secondary amino group and at least one hydroxyl group, wherein the fraction of amino alcohols having a secondary amino group, based on the total amount of e), is at least 60% by weight;
and dissolving the resulting hydroxy-functional polyurethane containing urea groups in water, wherein said dissolution in water is preceded or accompanied by the reaction of the acid groups or tertiary amino groups of a) with a neutralizing agent.

2. The process of claim 1, wherein c) is composed of
c1) from 27% to 73% by weight of at least one difunctional isocyanate selected from the group consisting of hexamethylene diisocyanate, isophorone diisocyanate, 2,4-diisocyanatotoluene and/or 2,6-diisocyanatotoluene, and 4,4′diisocyanatodicyclohexylmethane; and
c2) from 73% to 27% by weight of at least one polyisocyanate having on average more than two isocyanate groups with uretdione, biuret, isocyanurate, allophanate, carbodiimide, iminooxadiazinedione, oxadiazinetrione, urethane, and/or urea structural units based on hexamethylene diisocyanate.

3. The process of claim 1, wherein component e) is an amino alcohol having exclusively one secondary amino group and one or two hydroxyl groups.

4. The process of claim 1, wherein said hydroxy-functional polyurethane containing urea groups is present, prior to dissolution in water, as a non-aqueous dispersion in an organic solvent.

5. An aqueous solution of a hydroxy-functional polyurethane containing urea groups obtained by the process of claim 1.

6. A polyurethane system comprising as component A) the aqueous solution of claim 5.

7. The polyurethane system of claim 6, wherein said polyurethane system further comprises an optionally hydrophilically modified polyisocyanate B).

8. The polyurethane system of claim 7, wherein B) consists of at least one hydrophobic polyisocyanate crosslinker based on hexamethylene diisocyanate.

9. The aqueous solution of claim 5, wherein said aqueous solution is stable to freezing.

10. A water-soluble, hydroxy-functional polyurethane containing urea groups, having a hydroxyl group content in the range of from 2% to 10% by weight and a level of urea groups, calculated as —NH—CO—NH—, derived from amino alcohols having a primary or secondary amino group and at least one hydroxyl group in the range of from 3% to 20% by weight, based in each case on the weight of said, water-soluble, hydroxy-functional polyurethane containing urea groups, obtained by preparing a NCO-functional prepolymer by reacting
a) at least one hydroxy- and/or amino-functional hydrophilicizing agent having at least one acid group and/or the salt of an acid group, or having at least one tertiary amino group and/or the salt of a tertiary amino group;
b) at least one polyol;
c) at least one polyisocyanate;
d) optionally, other hydroxy- and/or amino-functional compounds, different from a), b), and e);
and reacting said NCO-functional prepolymer with
e) an amino alcohol component, comprising an amino alcohol having a primary or secondary amino group and at least one hydroxyl group, wherein the fraction of amino alcohols having a secondary amino group, based on the total amount of e), is at least 60% by weight;
wherein the tertiary amino groups or acid groups in the resulting water-soluble, hydroxy-functional polyurethane containing urea groups which originate from a) are optionally present in their salt form as a result of whole or partial neutralization.

11. A polyurethane system comprising as component A) the hydroxy-functional polyurethane containing urea groups of claim 10.

12. The polyurethane system of claim 11, wherein said polyurethane system further comprises an optionally hydrophilically modified polyisocyanate B).

13. The polyurethane system of claim 12, wherein B) consists of at least one hydrophobic polyisocyanate crosslinker based on hexamethylene diisocyanate.

14. A polyurethane obtained from the polyurethane system of claim 8.

15. The polyurethane of claim 14, wherein said polyurethane is a paint, coating material, sealant, liquid ink, printing ink, size, adhesion promoter, or reactive diluent applied in one or more layers.

16. A substrate coated with the polyurethane of claim 14.
